(19) United States
(12) Patent Application Publication
(10) Pub. No.: US 2026/0094766 A1
(43) Pub. Date: Apr. 2, 2026

(54) MULTILAYER CERAMIC CAPACITOR

(71) Applicant: Murata Manufacturing Co., Ltd., Nagaokakyo-shi (JP)

(72) Inventors: Yuuta Onodera, Nagaokakyo-shi (JP); Kazuhisa UCHIDA, Nagaokakyo-shi (JP)

(21) Appl. No.: 19/413,066

(22) Filed: Dec. 9, 2025

Related U.S. Application Data
(63) Continuation of application No. PCT/JP2024/014057, filed on Apr. 5, 2024.

(30) Foreign Application Priority Data
Jun. 21, 2023 (JP) 2023-101929

(51) Int. Cl. H01G 4/008; H01G 4/12; H01G 4/232; H01G 4/248; H01G 4/30

(52) U.S. Cl. CPC H01G 4/008; H01G 4/12; H01G 4/2325; H01G 4/248; H01G 4/30

(57) ABSTRACT

In a multilayer ceramic capacitor, a first internal electrode layer includes a first end surface-side exposed portion exposed to a first end surface side, a second internal electrode layer includes a second end surface-side exposed portion exposed to a second end surface side, and oxide films in the first and second end surface-side exposed portions. The oxide films include first and second oxide films respectively in the first and second end surface-side exposed portions. The first oxide films are provided at both ends in a width direction of the first end surface-side exposed portion, and the second oxide films are provided at both ends in the width direction of the second end surface-side exposed portion.

### CROSS REFERENCE TO RELATED APPLICATIONS

This application claims the benefit of priority to Japanese Patent Application No. 2023-101929 filed on Jun. 21, 2023 and is a Continuation Application of PCT Application No. PCT/JP2024/014057 filed on Apr. 5, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are each manufactured by laminating a ceramic green sheet and two ceramic green sheets on which an electrically conductive paste is printed on the ceramic green sheet, and a margin portion where the electrically conductive paste is not printed exists around the electrically conductive paste.

In order to achieve higher capacitance, these multilayer ceramic capacitors each have been developed to increase capacitance by printing the electrically conductive paste on the ceramic green sheet over as wide an area as possible. For example, Japanese Unexamined Patent Application, Publication No. 2016-143709 discloses such a technology. In addition, Japanese Unexamined Patent Application, Publication No. 7266969 describes a technology for attaching a side margin portion later for the purpose of increasing the relative area of the internal electrode.

When advancing higher capacitance, an internal electrode layer paste is applied to the margin portion where the internal electrode layer paste is not printed on the ceramic green sheet in order to secure a large effective area of the internal electrode layer that contributes to the capacitance generation of the multilayer ceramic capacitor. Normally, the thickness of the Cu base electrode layer near the external electrode ridge portion of the multilayer ceramic capacitor is thinner than the thickness of the base electrode layer other than the ridge portion. In addition, within the Cu base electrode layer, there exists a pure Cu layer, and a Ni—Cu alloy layer within the base electrode layer due to Ni, which is one of the metal materials of the internal electrode layer, diffusing into the Cu of the base electrode layer. It is known that the pure Cu layer within the base electrode layer does not allow moisture to pass therethrough, but the Ni—Cu alloy layer allows moisture to pass through.

The thickness of the Cu base electrode layer at the ridge portion is thin. Therefore, when the Cu base electrode layer at the ridge portion is filled with the Ni—Cu alloy layer, there is a problem in that moisture from the outside or moisture included in the plated layer provided in or on the Cu base electrode layer reaches the internal electrode layer or the dielectric layer via the Ni—Cu alloy layer, thus deteriorating the insulation resistance of the multilayer ceramic capacitor.

### SUMMARY OF THE INVENTION

Example embodiments of the present invention provide multilayer ceramic capacitors that are each able to reduce or prevent moisture penetration from a base electrode layer to an internal electrode layer or a dielectric layer and reduce or prevent deterioration of insulation resistance even when increasing capacitance.

An example embodiment of the present invention provides a multilayer ceramic capacitor which includes a multilayer body including a plurality of dielectric layers and a plurality of internal electrode layers that are laminated, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, a plurality of first internal electrode layers each on a corresponding one of the plurality of dielectric layers and each exposed at the first end surface, a plurality of second internal electrode layers each on a corresponding one of the plurality of dielectric layers and each exposed at the second end surface, a first base electrode layer in contact with the plurality of first internal electrode layers, and a second base electrode layer in contact with the plurality of second internal electrode layers. Each of the plurality of first internal electrode layers includes a first end surface-side exposed portion exposed on the first end surface. Each of the plurality of second internal electrode layers includes a second end surface-side exposed portion exposed on the second end surface. An oxide film is provided on each of the first end surface-side exposed portion and the second end surface-side exposed portion. The oxide film includes a first oxide film on the first end surface-side exposed portion, and a second oxide film on the second end surface-side exposed portion. The first oxide film is provided at both end portions in the width direction of the first end surface-side exposed portion. The second oxide film is provided at both end portions in the width direction of the second end surface-side exposed portion.

According to example embodiments of the present invention, multilayer ceramic capacitors that are each able to reduce or prevent moisture penetration from a base electrode layer to an internal electrode layer or a dielectric layer and reduce or prevent deterioration of insulation resistance even when advancing increased capacitance are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a cross-sectional view taken along the line I-I in FIG. 1.

FIG. 3 is a cross-sectional view taken along the line II-II in FIG. 1.

FIG. 4A is a view corresponding to a cross-sectional view taken along the line III-III in FIG. 1.

FIG. 4B is a view corresponding to a cross-sectional view taken along the line III-III in FIG. 1.

FIG. 5 is a view showing another formation state of an oxide film according to an example embodiment of the present invention.

FIG. 6 is a view showing an existence probability of an oxide film in a width direction according to an example embodiment of the present invention.

FIG. 7 is a view showing region divisions in a width direction of an end surface of an internal electrode according to an example embodiment of the present invention.

FIG. 8 is a view showing a WT cross section of a multilayer body according to an example embodiment of the present invention.

FIG. 9 is a view showing a formation mode of a Cu—Ni alloy layer according to an example embodiment of the present invention.

FIG. 10 is a view showing a state in which a ceramic green sheet is viewed in a plan view according to an example embodiment of the present invention.

FIG. 11 is a view showing a state of laminating ceramic green sheets according to an example embodiment of the present invention.

FIG. 12 is a view showing an outline of a multilayer body chip according to an example embodiment of the present invention.

FIG. 13 is a view showing a WT cross section of a multilayer body according to an example embodiment of the present invention.

FIG. 14 is a table showing results of Experimental Example 1 according to an example embodiment of the present invention.

FIG. 15 is a table showing results of Experimental Example 2 according to an example embodiment of the present invention.

### DETAILED DESCRIPTION OF THE EXAMPLE EMBODIMENTS

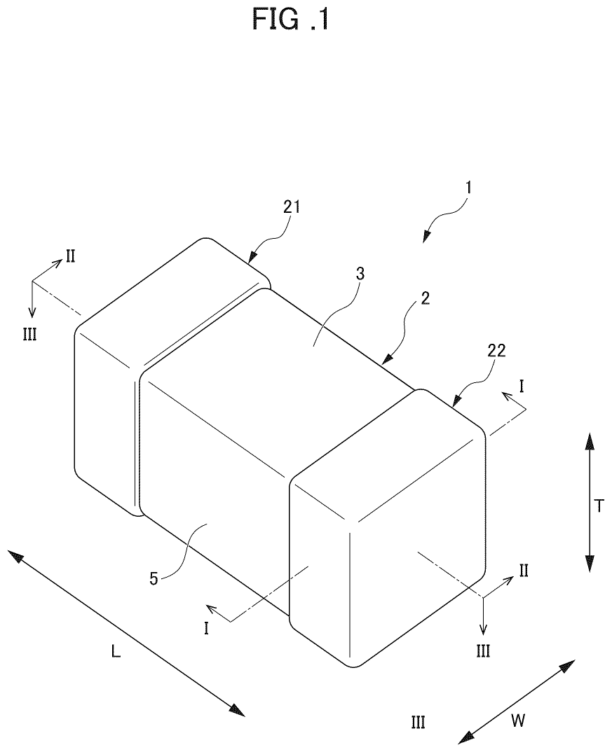

Example embodiments of the present invention will be described in detail below with reference to the drawings. FIG. 1 is a perspective view of a multilayer ceramic capacitor 1 according to an example embodiment of the present invention. The multilayer ceramic capacitor 1 includes a multilayer body 2 and external electrodes. The external electrodes include a first external electrode 21 and a second external electrode 22.

The multilayer body 2 includes a plurality of laminated dielectric layers and a plurality of laminated internal electrode layers. The multilayer body 2 has a rectangular or substantially rectangular parallelepiped shape.

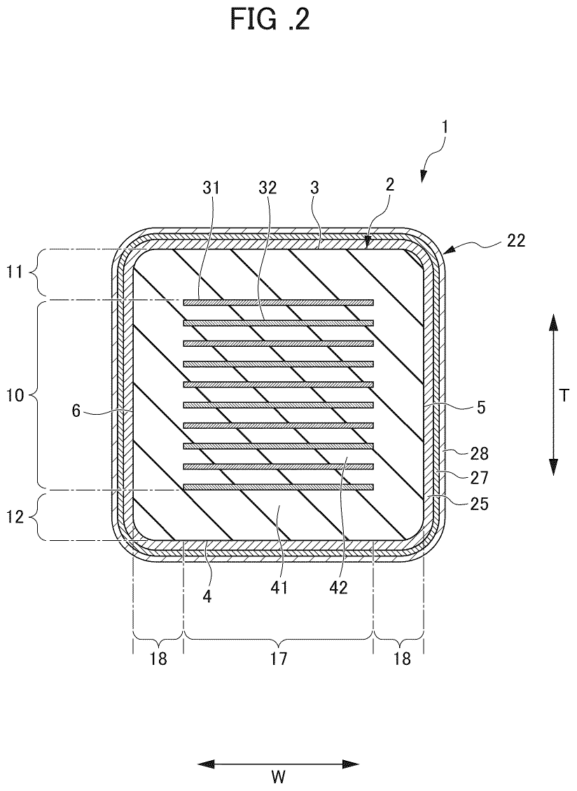

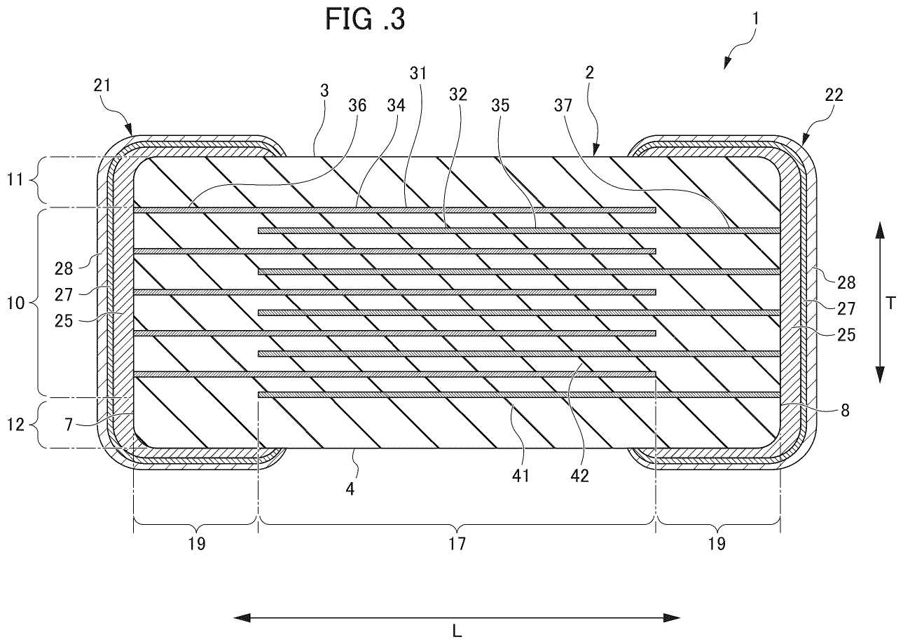

The dielectric layers include outer dielectric layers 41 and inner dielectric layers 42. The outer dielectric layers 41 and the inner dielectric layers 42 are not shown in FIG. 1. The outer dielectric layers 41 and the inner dielectric layers 42 are shown in FIG. 2, FIG. 3, etc.

The internal electrode layers include first internal electrode layers 31 and second internal electrode layers 32. The first internal electrode layers 31 and the second internal electrode layers 32 are not shown in FIG. 1. The first internal electrode layers 31 and the second internal electrode layers 32 are shown in FIG. 2, FIG. 3, etc.

With respect to the directions of the multilayer body 2, the lamination direction T refers to a direction in which the dielectric layers and the internal electrode layers are laminated. The width direction W refers to a direction orthogonal or substantially orthogonal to the lamination direction T. The length direction L refers to a direction orthogonal or substantially orthogonal to the lamination direction T and the width direction W.

With respect to the surfaces of the multilayer body 2, the first main surface 3 and the second main surface 4 refer to two surfaces opposed to each other in the lamination direction T. The first lateral surface 5 and the second lateral surface 6 refer to two surfaces opposed to each other in the width direction W. The first end surface 7 and the second end surface 8 refer to two surfaces opposed to each other in the length direction L.

With respect to the cross sections of the multilayer body 2, the WT cross section refers to a cross section parallel or substantially parallel to the width direction W and the lamination direction T. The cross section along the line I-I in FIG. 1 refers to a WT cross section.

The LT cross section refers to a cross section parallel or substantially parallel to the length direction L and the lamination direction T. The cross section along the line II-II in FIG. 1 refers to an LT cross section.

The LW cross section refers to a cross section parallel or substantially parallel to the length direction L and the width direction W. The cross section taken along line III-III in FIG. 1 refers to an LW cross section.

Regarding the outer periphery of the multilayer body 2, the corner portions refer to portions where three surfaces of the multilayer body 2 intersect with each other. The ridge portions refer to portions where two surfaces of the multilayer body 2 intersect with each other. The preferred shape of each of the corner portions is a rounded shape. The preferred shape of each of the ridge portions is a rounded shape.

At least a portion of the surface shape of the main surfaces, lateral surfaces, and end surfaces may include irregularities.

The number of dielectric layers is, for example, preferably fifteen or more and 2000 or less. This number includes the number of dielectric layers in the outer layer portions.

The dielectric layers include a ceramic material. The ceramic material includes dielectric ceramic. Examples of the main component of the dielectric ceramic include at least one of BaTiO₃, CaTiO₃, SrTiO₃, or CaZrO₃.

The ceramic material may include additives in addition to the dielectric ceramic. Examples of the additives include at least one of a Mn compound, a Fe compound, a Cr compound, a Co compound, or a Ni compound.

The material of the multilayer body 2 may be a material other than the above-described materials. By using other materials, it is possible to obtain multilayer ceramic electronic components each with a function different from that of a multilayer ceramic capacitor.

Examples of another material for the multilayer body 2 include piezoelectric ceramic. When piezoelectric ceramic is used, such a multilayer ceramic electronic component defines and functions as a ceramic piezoelectric element. Examples of the piezoelectric ceramic material include a PZT-based ceramic material. PZT stands for lead zirconate titanate.

Examples of other materials for the multilayer body 2 include semiconductor ceramic. When semiconductor ceramic is used, the multilayer ceramic electronic component defines and functions as a thermistor element. Examples of the semiconductor ceramic material include a spinel-based ceramic material.

Examples of other materials for the multilayer body 2 include magnetic ceramic. When magnetic ceramic is used, the multilayer ceramic electronic component defines and functions as an inductor element.

When the multilayer ceramic electronic component defines and functions as an inductor element, the internal electrode layer is a coil-shaped conductor. Examples of the magnetic ceramic material include a ferrite ceramic material.

A preferred thickness of each of the dielectric layers is, for example, about 0.1 μm or more and about 1 μm or less.

Based on FIG. 2, the cross-sectional configuration of the multilayer body 2 will be described. FIG. 2 is a cross-sectional view taken along the line I-I in FIG. 1. FIG. 2 is a WT cross-sectional view of the multilayer body 2.

The multilayer body 2 includes, in the lamination direction T, an effective layer portion 10, a first outer layer portion 11, and a second outer layer portion 12.

The effective layer portion 10 refers to a portion where the internal electrode layers are opposed to each other in the lamination direction T. The first outer layer portion 11 refers to a portion between the internal electrode layer closest to the first main surface 3 and the first main surface 3. The second outer layer portion 12 refers to a portion between the internal electrode layer closest to the second main surface 4 and the second main surface 4.

The first outer layer portion 11 is located adjacent to the first main surface 3 of the multilayer body 2. The first outer layer portion 11 refers to an aggregate of a plurality of dielectric layers located between the first main surface 3 and the internal electrode layer closest to the first main surface 3.

The second outer layer portion 12 is located adjacent to the second main surface 4 of the multilayer body 2. The second outer layer portion 12 refers to an aggregate of a plurality of dielectric layers located between the second main surface 4 and the internal electrode layer closest to the second main surface 4.

The effective layer portion 10 refers to a portion sandwiched between the first outer layer portion 11 and the second outer layer portion 12.

Regarding the dielectric layers, the outer dielectric layer 41 is a dielectric layer included in the first outer layer portion 11 and the second outer layer portion 12. The inner dielectric layer 42 is a dielectric layer included in the effective layer portion 10.

Regarding the dimensions of the multilayer body 2, the L dimension refers to the length of the multilayer body 2 in the length direction L. The W dimension refers to the length of the multilayer body 2 in the width direction W. The T dimension refers to the length of the multilayer body 2 in the lamination direction T. A preferred L dimension is, for example, about 0.2 mm or more and about 1.0 mm or less. A preferred W dimension is, for example, about 0.1 mm or more and about 0.5 mm or less. A preferred T dimension is, for example, about 0.1 mm or more and about 0.5 mm or less.

The multilayer body 2 includes a counter electrode portion 17 and multilayer body lateral portions 18 in the width direction W. The counter electrode portion 17 is a portion where the internal electrode layers are opposed to each other. The multilayer body lateral portions 18 refer to a portion between the counter electrode portion 17 and the first lateral surface 5, and a portion between the counter electrode portion 17 and the second lateral surface 6. The multilayer body lateral portions 18 are also referred to as W gaps.

The internal electrode layers will be described with reference to FIG. 2 and FIG. 3. FIG. 3 is a cross-sectional view taken along the line II-II in FIG. 1. FIG. 3 is an LT cross-sectional view of the multilayer body 2.

The internal electrode layers include a plurality of first internal electrode layers 31 and a plurality of second internal electrode layers 32. The first internal electrode layers 31 refer to internal electrode layers exposed at the first end surface 7. The second internal electrode layers 32 refer to internal electrode layers exposed at the second end surface 8.

The first internal electrode layers 31 each include a first counter portion 34 and a first extension portion 36. The first counter portion 34 refers to a portion of each of the first internal electrode layers 31 that is opposed to the second internal electrode layer 32. The first extension portion 36 refers to a portion of each of the first internal electrode layers 31 that extends from the first counter portion 34 toward the first end surface 7.

The second internal electrode layers 32 each include a second counter portion 35 and a second extension portion 37. The second counter portion 35 refers to a portion of each of the second internal electrode layers 32 that is opposed to the first internal electrode layer 31. The second extension portion 37 refers to a portion of each of the second internal electrode layers 32 that extends from the second counter portion 35 toward the second end surface 8.

Hereinafter, the counter portion may indicate a combination of the first counter portion 34 and the second counter portion 35. The shape of the counter portion is not particularly limited. A preferred shape of the counter portion is a rectangular or substantially rectangular shape. The shape of the corner portions of the counter portion may be rounded. The shape of the corner portions of the counter portion may be sloped. Being sloped may indicate a tapered shape. This tapered shape may be a shape with a gradual slope.

The length in the width direction W of the first counter portion 34 and the length in the width direction W of the first extension portion 36 may be the same or substantially the same length, or one of them may be shorter. The length in the width direction W of the second counter portion 35 and the length in the width direction W of the second extension portion 37 may be the same or substantially the same length, or one of them may be shorter.

The multilayer body 2 may include floating internal electrode layers. The floating internal electrode layers are not shown. The floating internal electrode layers refer to internal electrode layers that are not extended toward or exposed at the end surfaces. The counter electrode portion 17 may be divided into a plurality of portions by the floating internal electrode layers. The counter electrode portion 17 may include two or more portions by being divided by the floating internal electrode layers.

By dividing the counter electrode portion 17 into a plurality of portions, a plurality of capacitor components are provided between the opposed internal electrode layers. These capacitor components are connected in series. By connecting the capacitor components in series, the voltage applied to each capacitor component is reduced. By reducing the voltage applied to each capacitor component, it is possible to increase the withstand voltage of the multilayer ceramic capacitor.

Examples of materials for the internal electrode layers are metals such as Ni, Cu, Ag, Pd, or Au. The material of the internal electrode layers may include, for example, an alloy including at least one metal such as Ni, Cu, Ag, Pd, or Au. An example of the alloy is an Ag—Pd alloy.

Capacitance is generated by the counter portions of the internal electrode layers being opposed to each other with the dielectric layers interposed therebetween. By generating the capacitance, the characteristics of the capacitor are provided in the multilayer ceramic capacitor 1.

The preferred thickness of each of the internal electrode layers is, for example, about 0.1 μm or more and about 1.0 μm or less.

The total number of layers is defined as the sum of the number of the first internal electrode layers 31 and the number of the second internal electrode layers 32. The preferred total number of layers is, for example, fifteen or more and 2000 or less.

The configuration of the multilayer body 2 in the length direction L will be described. As shown in FIG. 3, the multilayer body 2 includes the counter electrode portion 17 and multilayer body end portions 19 in the length direction L. The counter electrode portion 17 refers to a portion where the internal electrode layers are opposed to each other. The multilayer body end portions 19 refer to a portion between the counter electrode portion 17 and the first end surface 7, and a portion between the counter electrode portion 17 and the second end surface 8. The multilayer body end portions 19 are also referred to as L gaps.

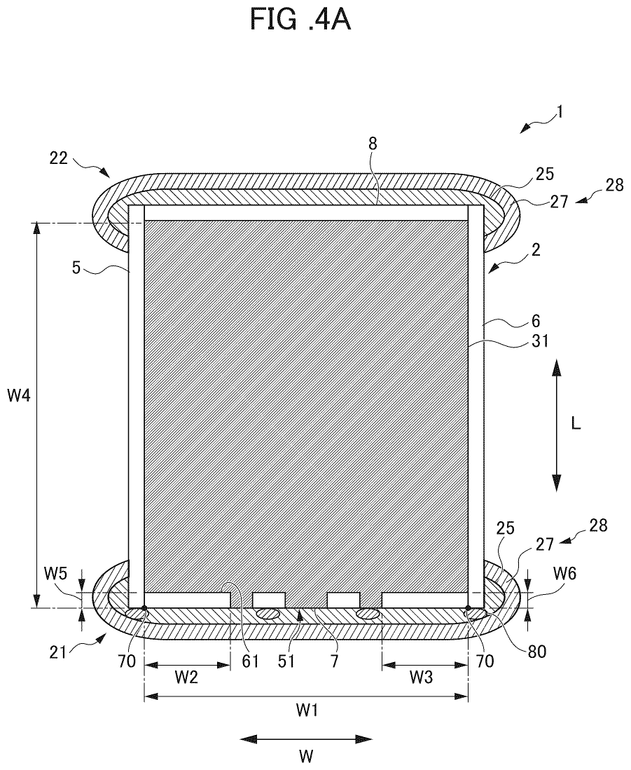

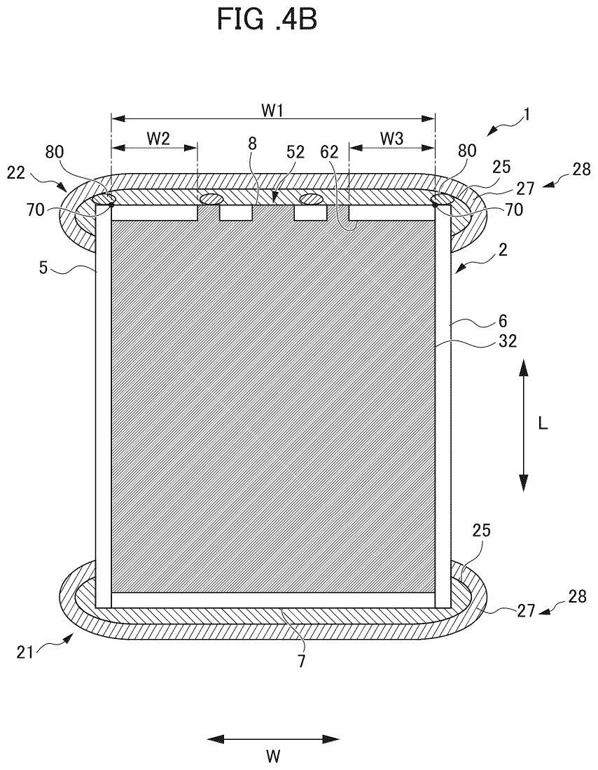

In the multilayer ceramic capacitor 1 of the present example embodiment, oxide films are provided at the end portions of the internal electrode layers. This will be described based on FIGS. 4A and 4B. FIGS. 4A and 4B are both views corresponding to the cross-sectional view taken along the line III-III in FIG. 1. FIG. 4A shows the first internal electrode layer 31. FIG. 4B shows the second internal electrode layer 32.

As shown in FIG. 4A, the first internal electrode layer 31 includes a first end surface-side exposed portion 51. The first end surface-side exposed portion 51 is a portion where the first internal electrode layer 31 is exposed on the first end surface 7. A first oxide film 61 is provided on the first end surface-side exposed portion 51. The oxide film is made of NiO.

Similarly, an oxide film is also provided for the second internal electrode layer 32. As shown in FIG. 4B, the second internal electrode layer 32 includes a second end surface-side exposed portion 52. The second end surface-side exposed portion 52 is a portion where the second internal electrode layer 32 is exposed on the second end surface 8. A second oxide film 62 is provided on the second end surface-side exposed portion 52. The oxide film is made of, for example, NiO.

Both end portions in the width direction W of the first end surface-side exposed portion 51 and both end portions in the width direction W of the second end surface-side exposed portion 52 are defined as width-direction both end portions 70.

The first oxide film 61 is provided at both end portions in the width direction W of the first end surface-side exposed portion 51. The second oxide film 62 is provided at both end portions in the width direction W of the second end surface-side exposed portion 52. Therefore, the multilayer ceramic capacitor 1 is less susceptible to the influence of moisture, particularly water vapor, as described later. Thus, deterioration of the insulation resistance of the multilayer ceramic capacitor 1 is reduced or prevented.

An example of a method for measuring the oxide film will be described. The first oxide film 61 provided on the first end surface-side exposed portion 51 and the second oxide film 62 provided on the second end surface-side exposed portion 52 can be confirmed by the following method, for example.

A surface extending from one end portion in the width direction W to the other end portion in the width direction W of the first internal electrode layer 31 is exposed by mechanical polishing from the first external electrode 21 on the end surface. Similarly, a surface extending from one end portion in the width direction W to the other end portion in the width direction W of the second internal electrode layer 32 is exposed by mechanical polishing from the second external electrode 22 on the end surface.

Thereafter, using, for example, a wavelength dispersion X-ray analyzer (hereinafter referred to as WDX) or an energy dispersive X-ray spectrometer (hereinafter referred to as EDS) on the exposed surface, portions where both Ni and oxygen are detected can be confirmed as oxide films.

The oxide film will be described more specifically. Hereinafter, the first oxide film 61 will be described as an example. However, the description also applies to the second oxide film 62.

The first oxide film 61 is provided most abundantly in the vicinity regions of the width-direction both end portions 70 of the first end surface 7 of the multilayer body 2.

The reason for providing the first oxide film 61 at the width-direction both end portions 70 of the first end surface 7 of the multilayer body 2 is as follows. When forming the base electrode layer 25 by immersing both end surfaces of the multilayer body 2 into electrically conductive paste that defines and functions as the base electrode layer 25 by a dipping method or the like, for example, the thickness of the base electrode layer 25 formed at the ridge portions of the multilayer body 2 tends to be thinner than that on surfaces other than the ridge portions of both end surfaces of the multilayer body 2.

As shown in FIG. 4A, a Cu—Ni alloy layer 80 is formed in the base electrode layer 25 by diffusion of Ni from the internal electrode layers into the base electrode layer 25 during the firing step of the base electrode layer 25. Therefore, the inside of the base electrode layer 25 that is thinly formed at the ridge portions of the multilayer body 2 is likely to be filled with the Cu—Ni alloy layer 80.

When the inside of the base electrode layer 25 that is thinly formed at the ridge portions is filled with the Cu—Ni alloy layer 80, the following problems occur.

When forming a Ni plated layer on the surface of the base electrode layer 25 after forming the base electrode layer 25, moisture included in the Ni plating solution remains in the Ni plated layer, and water vapor is generated in the Ni plated layer. The water vapor in the Ni plated layer does not diffuse into the pure Cu layer in the base electrode layer 25, but diffuses into the Cu—Ni alloy layer 80 in the base electrode layer 25.

Therefore, the water vapor in the Ni plated layer diffuses into the Cu—Ni alloy layer 80 and reaches the internal electrode layers and dielectric layers inside the multilayer body 2, causing deterioration of insulation resistance.

In addition, deterioration of insulation resistance also occurs due to moisture penetration from the outside into the multilayer body 2.

In the multilayer ceramic capacitor 1 of the present example embodiment, oxide films are provided on the internal electrode layers located at the width-direction both end portions 70 of the first end surface 7 and the second end surface 8 of the multilayer body 2. Therefore, it is possible to reduce or prevent the intrusion of water vapor and moisture diffused through the Cu—Ni alloy layer 80 into the multilayer body 2. Therefore, it is possible to reduce or prevent deterioration of the insulation resistance of the multilayer ceramic capacitor 1.

In addition, since an oxide film is provided at the width-direction both end portions 70 of the internal electrode layer, diffusion of Ni, which is a metal component of the internal electrode layer, to the base electrode layer 25 is prevented. Therefore, a Cu—Ni alloy layer 80 is not provided in the base electrode layer 25 near where the oxide film is provided. Thus, water vapor included in the Ni plated layer does not penetrate into the internal electrode layers or dielectric layers inside the multilayer body 2 via the Cu—Ni alloy layer 80. As a result, it is possible to reduce or prevent deterioration of the insulation resistance of the multilayer ceramic capacitor 1.

The placement of the first oxide film 61 in the width direction W will be described. As shown in FIG. 4A, the first oxide film 61 is most frequently provided in a range of, for example, about 0.5% or more and about 15% or less with respect to the total length in the width direction W of the first internal electrode layer 31 from the first lateral surface 5 of the multilayer body 2 toward the middle of the multilayer body 2 in the width direction W.

In the first end surface-side exposed portion 51, the first oxide film 61 is most frequently provided in a range of, for example, about 0.5% or more and about 15% or less with respect to the total length in the width direction W of the first internal electrode layer 31 from both end portions of the first end surface-side exposed portion 51 in the width direction W toward the middle in the width direction W.

In FIG. 4A, the length (W1) indicates the total length of the first internal electrode layer 31 in the width direction W. The length (W2) indicates the length from the end of the first internal electrode layer 31 adjacent to the first lateral surface 5 toward the middle of the multilayer body 2 in the width direction W. The length (W3) indicates the length from the end of the first internal electrode layer 31 adjacent to the second lateral surface 6 toward the middle of the multilayer body 2 in the width direction W.

The length (W2) is, for example, about 0.5% or more and about 15% or less of the length (W1). The length (W3) is, for example, about 0.5% or more and about 15% or less of the length (W1).

Since the first oxide film 61 is provided in a range of, for example, about 0.5% or more of the total length (W1) in the width direction W of the first internal electrode layer 31 from the first lateral surface 5 and the second lateral surface 6 of the multilayer body 2 toward the middle of the multilayer body 2 in the width direction W, it is possible to further prevent penetration of moisture diffused from the Cu—Ni alloy layer 80.

Since the first oxide film 61 is provided in a range of, for example, about 15% or less of the total length (W1) in the width direction W of the first internal electrode layer 31 from the first lateral surface 5 and the second lateral surface 6 of the multilayer body 2 toward the middle of the multilayer body 2 in the width direction W, it is possible to further ensure electrical conductivity between the internal electrode layer and the base electrode layer 25.

When the first oxide film 61 is provided in a range of, for example, less than about 0.5% of the total length (W1), it is not possible to sufficiently prevent penetration of moisture diffused from the Cu—Ni alloy layer 80.

When the first oxide film 61 is provided in a range, for example, exceeding about 15% of the total length (W1), it is not possible to sufficiently ensure electrical conductivity between the internal electrode layer and the base electrode layer 25. Therefore, it is not possible to ensure the desired capacitance.

The formation ratio of the oxide film with respect to the total length (W1) of the internal electrode layer in the width direction W can be measured by the following method, for example.

A surface is exposed by mechanical polishing from the first external electrode 21 adjacent to the first end surface 7 so that a surface extending from one end portion to the other end portion of the first internal electrode layer 31 in the width direction W is exposed. The length from one end portion to the other end portion of the exposed first internal electrode layer 31 in the width direction W is defined as the total length (W1) of the first internal electrode layer 31 in the width direction W.

The total length (W1) of the first internal electrode layer 31 in the width direction W is measured using a scanning electron microscope (device name: JSM-7900F (available from JEOL Ltd.), hereinafter referred to as SEM). The conditions when using the SEM are: magnification: about ×15000, field of view: about 8×6 μm, acceleration voltage: about 15 kV, stage tilt angle: about 0°, sample stage: about 0°, observation image: backscattered electron image, pretreatment, etc.: none (high vacuum).

The length (W2) from the end portion of the first internal electrode layer 31 adjacent to the first lateral surface 5 to the end portion of the oxide film provided toward the second lateral surface 6 (toward the middle in the width direction W) is measured using SEM. The conditions when using the SEM are the same or substantially the same as those for measuring W1.

The formation ratio of the oxide film provided adjacent to the first lateral surface 5 is calculated by dividing the length (W2) from the end portion of the first internal electrode layer 31 adjacent to the first lateral surface 5 to the end portion of the oxide film provided toward the second lateral surface 6 (toward the middle in the width direction W) by the total length (W1) of the first internal electrode layer 31 in the width direction W. The calculation formula is as follows. Formation ratio of oxide film adjacent to the first lateral surface 5=W2/W1×100

The length (W3) from the end portion of the first internal electrode layer 31 adjacent to the second lateral surface 6 to the end portion of the oxide film formed toward the first lateral surface 5 (toward the middle in the width direction W) is measured using SEM. The conditions when using the SEM are the same or substantially the same as those for measuring W1.

The formation ratio of the oxide film provided adjacent to the second lateral surface 6 is calculated by dividing the length (W3) from the end portion of the first internal electrode layer 31 adjacent to the second lateral surface 6 to the end portion of the oxide film formed toward the first lateral surface 5 (toward the middle in the width direction W) by the total length (W1) of the first internal electrode layer 31 in the width direction W. The calculation formula is as follows. Formation ratio of oxide film adjacent to the second lateral surface 6=W3/W1×100

An example of specific numerical values is described. The following description uses, as an example, a multilayer ceramic capacitor 1 with L dimension×W dimension×T dimension=about 0.6 mm×about 0.3 mm×about 0.3 mm.

The first oxide film 61 is provided from both end portions of the first end surface-side exposed portion 51 of the multilayer body 2 in the width direction W toward the middle of the multilayer body 2 in the width direction W with a dimension of, for example, about 5 μm or more and about 50 μm or less.

Since the first oxide film 61 is provided at about 5 μm or more from both end portions of the first end surface-side exposed portion 51 of the multilayer body 2 in the width direction W toward the middle of the multilayer body 2 in the width direction W, it is possible to prevent penetration of moisture diffused from the Cu—Ni alloy layer 80.

Since the first oxide film 61 is provided at, for example, about 50 μm or less from both end portions of the first end surface-side exposed portion 51 of the multilayer body 2 in the width direction W toward the middle of the multilayer body 2 in the width direction W, it is possible to ensure electrical conductivity between the internal electrode layer and the base electrode layer 25.

When the first oxide film 61 is provided less than about 5 μm from both end portions in the width direction W of the first end surface-side exposed portion 51 of the multilayer body 2 toward the middle in the width direction W of the multilayer body 2, it is not possible to sufficiently prevent the penetration of moisture diffused from the Cu—Ni alloy layer 80.

When the first oxide film 61 is formed exceeding about 50 μm from both end portions in the width direction W of the first end surface-side exposed portion 51 of the multilayer body 2 toward the second end surface 8 of the multilayer body 2, it is not possible to sufficiently ensure the electrical conductivity between the internal electrode layer and the base electrode layer 25. Therefore, it is not possible to ensure a desired capacitance.

The placement of the oxide film in the length direction L will be described by taking the first oxide film 61 as an example. The following description also applies to the second oxide film 62. As shown in FIG. 4A, the first oxide film 61 is provided in a range of, for example, about 0.01% or more and about 0.5% or less with respect to the total length in the length direction L of the first internal electrode layer 31 from the width-direction both end portions 70 of the first end surface-side exposed portion 51 of the multilayer body 2 toward the second end surface 8 of the multilayer body 2.

In FIG. 4A, the length (W4) indicates the total length in the length direction L of the first internal electrode layer 31 from the width-direction both end portions 70 of the first end surface 7 of the multilayer body 2 toward the second end surface 8 of the multilayer body 2. The length (W5) indicates the length of the first oxide film 61 from the width-direction both end portions 70 adjacent to the first lateral surface 5 in the width direction W of the first end surface 7 of the multilayer body 2 toward the second end surface 8 of the multilayer body 2. The length (W6) indicates the length of the first oxide film 61 from the width-direction both end portions 70 adjacent to the second lateral surface 6 in the width direction W of the first end surface 7 of the multilayer body 2 toward the second end surface 8 of the multilayer body 2.

The length (W5) is, for example, about 0.01% or more and about 0.5% or less of the length (W4). The length (W5) is, for example, about 0.01% or more and about 0.5% or less of the length (W6).

Since the first oxide film 61 is provided, for example, about 0.01% or more with respect to the total length in the length direction L of the first internal electrode layer 31 from the width-direction both end portions 70 of the first end surface-side exposed portion 51 of the multilayer body 2 toward the second end surface 8 of the multilayer body 2, it is possible to reduce or prevent the penetration of moisture diffused from the Cu—Ni alloy layer 80.

Since the first oxide film 61 is provided, for example, about 0.5% or less from the width-direction both end portions 70 of the first end surface-side exposed portion 51 of the multilayer body 2 toward the second end surface 8 of the multilayer body 2, it is possible to ensure a large effective area of the internal electrode layer. Therefore, it is possible to ensure a large capacitance.

When the first oxide film 61 is provided, for example, less than about 0.01% with respect to the total length in the length direction L of the first internal electrode layer 31 from the width-direction both end portions 70 of the first end surface-side exposed portion 51 of the multilayer body 2 toward the second end surface 8 of the multilayer body 2, it is not possible to sufficiently reduce or prevent the penetration of moisture diffused from the Cu—Ni alloy layer 80.

When the first oxide film 61 is provided, for example, exceeding about 0.5% with respect to the total length in the length direction L of the first internal electrode layer 31 from the width-direction both end portions 70 of the first end surface-side exposed portion 51 of the multilayer body 2 toward the second end surface 8 of the multilayer body 2, it is not possible to sufficiently ensure the area within the internal electrode layer. Therefore, it is not possible to ensure a desired capacitance.

The oxide film in the length direction L is affected by the formation of the oxide film in the width direction W. Therefore, the formation size of the oxide film in the length direction L is determined by the formation size of the oxide film formed in the width direction W.

An example of a method for measuring an oxide film in the length direction L will be described. An oxide film of about 0.5% or more and about 15% or less provided from the width-direction both end portions 70 of the first end surface 7 of the multilayer body 2 toward the second end surface 8 of the multilayer body 2, and an oxide film of about 0.5% or more and about 15% or less provided from the width-direction both end portions 70 of the second end surface 8 of the multilayer body 2 toward the first end surface 7 of the multilayer body 2 can be measured by the following measurement method.

A surface where the internal electrode layer is exposed is measured using an EDS (energy dispersive spectrometer) or WDS (wavelength dispersive spectrometer) as an X-ray spectrometer, and a portion where both Ni and oxygen are detected can be confirmed as an oxide film.

An example of a method for measuring a formation ratio of an oxide film with respect to a total length of the internal electrode layer in the length direction L will be described. The formation ratio of the oxide film with respect to the total length of the internal electrode layer in the length direction L can be measured by the following method, for example.

A surface is exposed by mechanical polishing so that a surface extending from one end portion in the length direction L to the other end portion in the length direction L of the first internal electrode layer 31 is exposed from the first external electrode 21 adjacent to the first lateral surface 5 and the second external electrode 22 adjacent to the first lateral surface 5.

A length from one end portion to the other end portion in the length direction L of the exposed first internal electrode layer 31 is defined as a total length (W4) in the length direction of the first internal electrode layer 31. The total length (W4) in the length direction of the first internal electrode layer 31 is measured using SEM.

A length (W5) of an oxide film formed from the width-direction both end portions 70 of the first internal electrode layer 31 adjacent to the first lateral surface 5 toward the second end surface 8 (toward the middle in the length direction L) is measured using SEM. The conditions when using SEM are the same as those when measuring W1.

A formation ratio of the oxide film provided adjacent to the first lateral surface 5 is calculated by dividing the length (W5) of the oxide film provided from the end portion of the first internal electrode layer 31 adjacent to the first lateral surface 5 toward the second end surface 8 adjacent to the first lateral surface 5 (toward the middle in the length direction L) by the total length (W4) in the length direction L of the first internal electrode layer 31. The calculation formula is as follows. Oxide film formation ratio from the first end surface 7 to the second end surface 8 adjacent to the first lateral surface 5=W5/W4×100

A length (W6) of an oxide film provided from the end portion of the first internal electrode layer 31 adjacent to the first lateral surface 5 toward the second end surface 8 (toward the middle in the length direction L) is measured using SEM. The conditions when using SEM are the same or substantially the same as those when measuring W1.

A formation ratio of the oxide film provided adjacent to the first lateral surface 5 is calculated by dividing the length (W6) of the oxide film provided from the end portion of the first internal electrode layer 31 adjacent to the first lateral surface 5 toward the second end surface 8 adjacent to the first lateral surface 5 (toward the middle in the length direction L) by the total length (W4) in the length direction L of the first internal electrode layer 31. The calculation formula is as follows. Oxide film formation ratio from the first end surface 7 to the second end surface 8 adjacent to the second lateral surface 6=W6/W4

An example of specific numerical values will be described. The following description describes, as an example, a multilayer ceramic capacitor 1 having L dimension×W dimension×T dimension=about 0.6 mm×about 0.3 mm×about 0.3 mm.

The first oxide film 61 is provided in a range of about 0.1 μm or more and about 1 μm or less from the width-direction both end portions 70 of the first end surface 7 of the multilayer body 2 toward the second end surface 8 of the multilayer body 2.

Since the first oxide film 61 is provided at about 0.1 μm or more from the width-direction both end portions 70 of the first end surface 7 of the multilayer body 2 toward the second end surface 8 of the multilayer body 2, it is possible to reduce or prevent penetration of moisture diffused from the Cu—Ni alloy layer 80.

Since the first oxide film 61 is provided at about 1 μm or less from the width-direction both end portions 70 of the first end surface 7 of the multilayer body 2 toward the second end surface 8 of the multilayer body 2, it is possible to secure a large effective area of the internal electrode layer. Therefore, it is possible to secure a large capacitance.

When the first oxide film 61 is provided less than about 0.1 μm from the width-direction both end portions 70 of the first end surface 7 of the multilayer body 2 toward the second end surface 8 of the multilayer body 2, it is not possible to sufficiently prevent penetration of moisture diffused from the Cu—Ni alloy layer 80.

When the first oxide film 61 is provided exceeding about 1 μm from the width-direction both end portions 70 of the first end surface 7 of the multilayer body 2 toward the second end surface 8 of the multilayer body 2, it is not possible to secure a sufficient inner area of the internal electrode layer. Therefore, it is not possible to secure a desired capacitance.

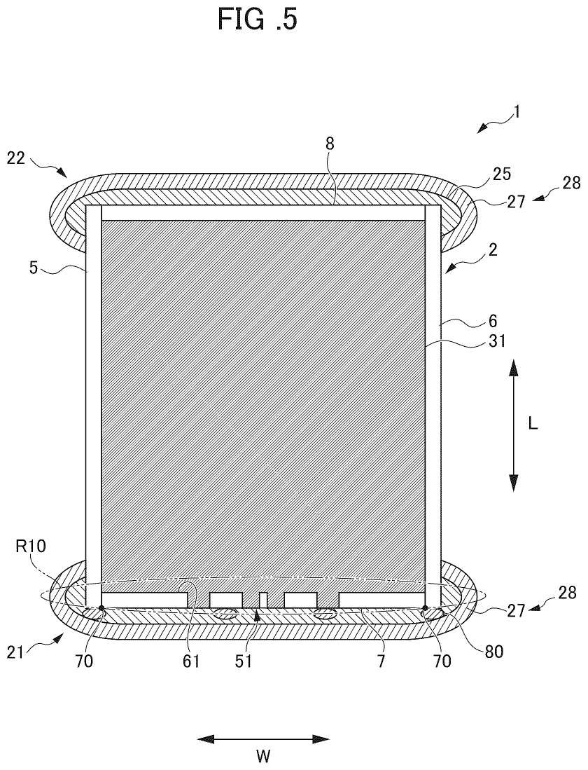

The formation state of the first oxide film 61 of the internal electrode layer in the width direction W will be described. FIG. 5 is a diagram showing another formation state of the first oxide film 61 in the present example embodiment. FIG. 5 shows an LW cross section of the first internal electrode layer 31.

The first oxide film 61 shown in FIG. 4A and the first oxide film 61 shown in FIG. 5 differ in the formation position of the first oxide film 61 in the width direction W. The first oxide film 61 shown in FIG. 5 is provided not only at the width-direction both end portions 70 but also in the middle in the width direction W. By changing the manufacturing conditions described later, it is possible to change the formation position of the oxide film.

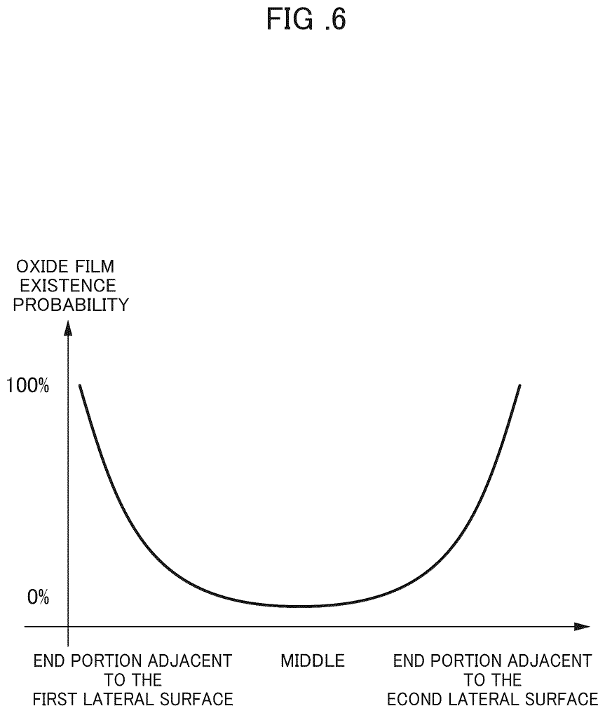

FIG. 6 is a graph showing the existence probability in the width direction W of the oxide film in the vicinity of the end surface of the multilayer body 2. FIG. 6 conceptually shows the existence probability of the oxide film within the range of the dashed line box R10 shown in FIG. 5. The horizontal axis of the graph shown in FIG. 6 indicates the position in the width direction W in the vicinity of the end surface of the multilayer body 2. The vertical axis of the graph shown in FIG. 6 indicates the existence probability of the oxide film.

As shown in FIG. 6, the existence probability of the first oxide film 61 decreases from both end portions in the width direction W of the first end surface-side exposed portion 51 toward the middle in the width direction W of the multilayer body 2, and the oxide film decreases as it approaches the middle in the width direction W of the multilayer body 2.

Normally, the base electrode layer 25 is provided with the thinnest thickness in the vicinity of the ridge portion. When the base electrode layer 25 other than in the vicinity of the ridge portion is partially provided to be thin to the extent that it is not detected as a defective product in appearance inspection during manufacturing, since the first oxide film 61 is provided less as it approaches the middle in the width direction W of the multilayer body 2, in other words, since the first oxide film 61 is provided more as it approaches the width-direction both end portions 70 of the multilayer body 2, it is possible to reduce or prevent penetration of moisture from the location where the first oxide film 61 is provided.

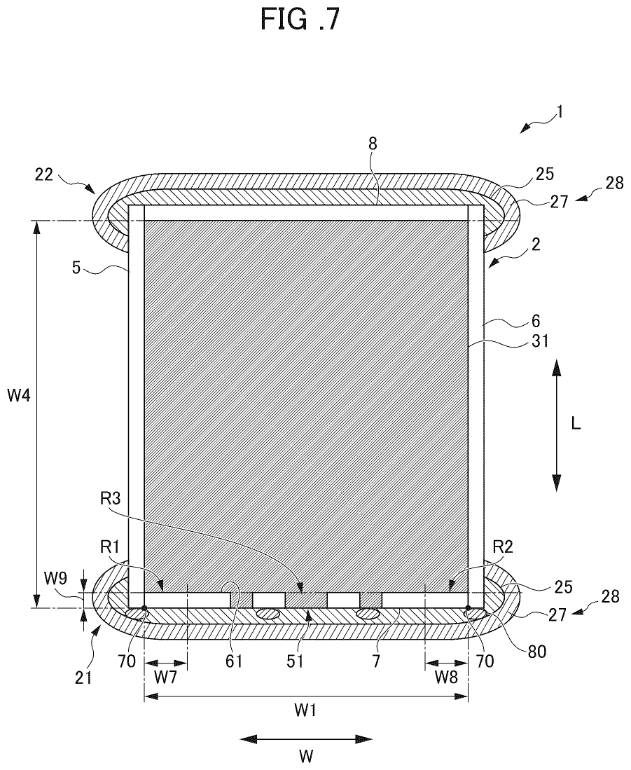

The formation state of the oxide film in the width direction W will be described by dividing the end surface into regions. In particular, the formation of the oxide film in the vicinity of the middle of the end surface, which is sandwiched between the width-direction both end portions 70, will be described. FIG. 7 is a diagram showing the division of regions in the width direction W of the end surface of the internal electrode.

As shown in FIG. 7, the region in the vicinity of the end surface of the internal electrode is divided into a first region R1, a second region R2, and a third region R3.

The first region R1 refers to a region where the first oxide film 61 is provided in a range of, for example, about 0.5% or more and about 15% or less with respect to the total length (W1) in the width direction W of the first internal electrode layer 31 from the first lateral surface 5 of the multilayer body 2 toward the middle in the width direction W of the multilayer body 2, and where the first oxide film 61 is provided in a range of, for example, about 0.01% or more and about 0.5% or less with respect to the total length (W4) in the length direction L of the first internal electrode layer 31 from the width-direction both end portions 70 of the first end surface 7 of the multilayer body 2 toward the second end surface 8 of the multilayer body 2.

The second region R2 refers to a region where the first oxide film 61 is provided in a range of, for example, about 0.5% or more and about 15% or less with respect to the total length (W1) in the width direction W of the first internal electrode layer 31 from the second lateral surface 6 of the multilayer body 2 toward the middle in the width direction W of the multilayer body 2, and where the first oxide film 61 is provided in a range of, for example, about 0.01% or more and about 0.5% or less with respect to the total length (W4) in the length direction L of the first internal electrode layer 31 from the width-direction both end portions 70 of the first end surface 7 of the multilayer body 2 toward the second end surface 8 of the multilayer body 2.

The third region R3 refers to a region between the first region R1 and the second region R2 in the width direction W.

The length (W7) shown in FIG. 7 is, for example about 15% of the total length (W1) in the width direction W of the first internal electrode layer 31. Similarly, the length (W8) shown in FIG. 7 is 15% of the total length (W1) in the width direction W of the first internal electrode layer 31. Further, for example, the length (W9) shown in FIG. 7 is about 0.5% of the total length (W4) in the length direction L of the first internal electrode layer 31.

In addition, the length (W7), the length (W8), and the length (W9) shown in FIG. 7 indicate concepts and may not correspond to actual numerical values or ratios. Further, the lower limit values of the ranges when determining the first region R1 and the second region R2 are not shown.

In FIG. 7, the region where the range indicated by the length (W7) and the range indicated by the length (W9) overlap is approximately the first region R1. Similarly, in FIG. 7, the region where the range indicated by the length (W8) and the range indicated by the length (W9) overlap is approximately the second region R2. In the width direction W, the region between the first region R1 and the second region R2 is the third region R3.

It is preferable that the first oxide film 61 in the third region R3 is provided in a range of, for example, about 0.4% or more and about 10% or less with respect to the total length (W1) in the width direction W of the first internal electrode layer 31. With such a configuration, the internal electrode layer and the base electrode layer 25 have high electrical conductivity, and it is possible to reduce or prevent deterioration of insulation resistance.

By providing the first oxide film 61 in the third region R3, for example, about 0.4% or more with respect to the total length (W1) in the width direction W of the first internal electrode layer 31, it is possible to reduce or prevent the penetration of moisture diffused from the Cu—Ni alloy layer 80.

By providing the first oxide film 61 in the third region R3 of, for example, about 10% or less with respect to the total length (W1) in the width direction W of the first internal electrode layer 31, it is possible to ensure the electrical conductivity between the internal electrode layer and the base electrode layer 25.

When the first oxide film 61 in the third region R3 is provided, for example, less than about 0.4% with respect to the total length (W1) in the width direction W of the first internal electrode layer 31, it is not possible to sufficiently reduce or prevent the penetration of moisture diffused from the Cu—Ni alloy layer 80.

When the first oxide film 61 in the third region R3 is provided, for example, exceeding about 10% with respect to the total length (W1) in the width direction W of the first internal electrode layer 31, it is not possible to ensure the electrical conductivity between the internal electrode layer and the base electrode layer 25.

By providing the oxide film in the third region R3, for example, about 0.4% or more and about 10% or less with respect to the total length (W1) in the width direction W of the first internal electrode layer 31, it is possible to further reduce or prevent the deterioration of insulation resistance. As a result, it is possible to achieve high moisture resistance reliability, and it is possible to achieve high electrical conductivity.

When the oxide film in the third region R3 is, for example, less than about 0.4% with respect to the total length (W1) in the width direction W of the first internal electrode layer 31, the oxide film is not sufficiently provided in the third region R3 and, therefore, the deterioration of insulation resistance cannot be reduced or prevented.

When the oxide film in the third region, for example, exceeds about 10% with respect to the total length (W1) in the width direction W of the first internal electrode layer 31, although the deterioration in insulation resistance can be reduced or prevented, the decrease in electrical conductivity is significant, and connection reliability cannot be sufficiently ensured. Therefore, it is not possible to achieve both reduction or prevention of deterioration in insulation resistance and maintenance of electrical conductivity.

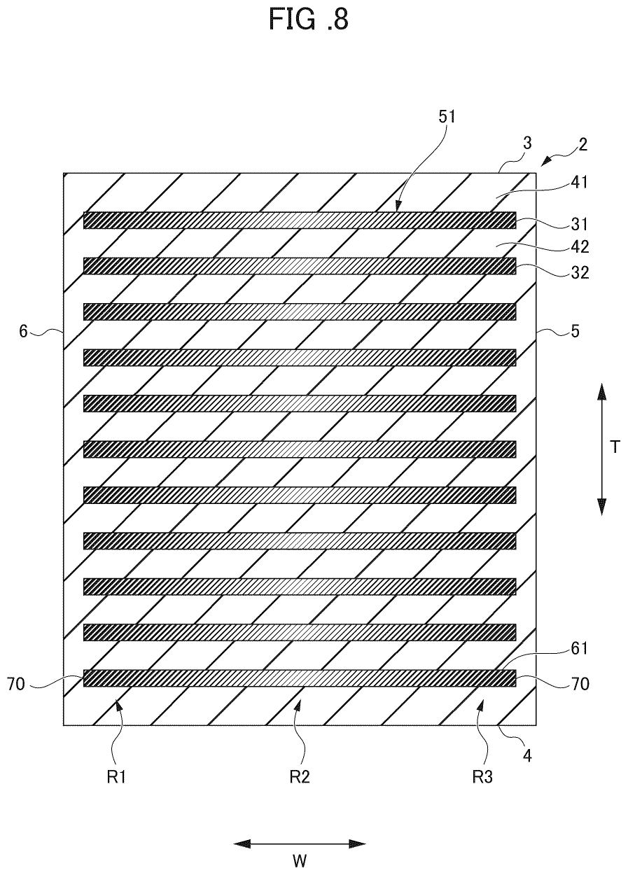

Based on FIG. 8, the placement of the oxide film in the WT cross section of the multilayer body 2 will be described. FIG. 8 is a WT cross-sectional view of the multilayer body 2 showing the first end surface-side exposed portion 51. As described based on FIGS. 6 and 7, the existence probability of the oxide film is higher at the lateral surface-side end portions than at the middle in the end surface-side exposed portion. For example, regarding the first end surface-side exposed portion 51, as shown in FIG. 8, in any of the first internal electrode layers 31 in the lamination direction T, more of the first oxide film 61 is provided in the first region R1 and the third region R3 than in the second region R2.

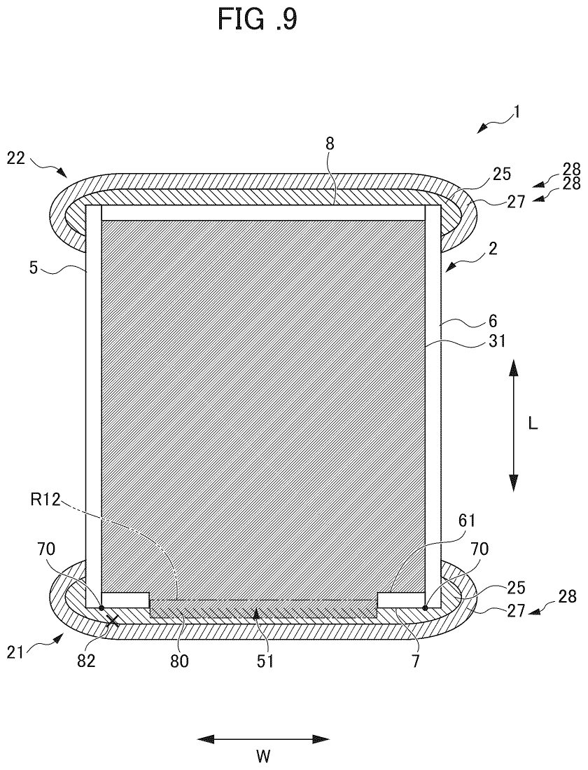

Based on FIG. 9, the formation mode of the Cu—Ni alloy layer 80 will be supplementarily described. FIG. 9 is a view corresponding to the cross-sectional view taken along the line III-III in FIG. 1. In FIG. 4A and the like, the configuration of the Cu—Ni alloy layer 80 is shown by an elliptical shape. However, this is a simulated example, and the Cu—Ni alloy layer 80 does not necessarily have an elliptical shape. For example, as shown as region R12 in FIG. 9, in the vicinity of the first end surface-side exposed portion 51 of the first internal electrode layer 31, the Cu—Ni alloy layer 80 may be provided across the first internal electrode layer 31 and the base electrode layer 25 in a portion in the width direction W where the first oxide film 61 is not provided.

The external electrodes will be described. The external electrodes include a first external electrode 21 and a second external electrode 22.

The first external electrode 21 is an external electrode connected to the first internal electrode layers 31. The first external electrode 21 is provided on the first end surface 7.

The first external electrode 21 may be provided on a portion of the first main surface 3, a portion of the second main surface 4, a portion of the first lateral surface 5, and a portion of the second lateral surface 6. In the present example embodiment, the first external electrode 21 extends from the first end surface 7 to a portion of the first main surface 3, a portion of the second main surface 4, a portion of the first lateral surface 5, and a portion of the second lateral surface 6.

The second external electrode 22 is an external electrode connected to the second internal electrode layers 32. The second external electrode 22 is provided on the second end surface 8.

The second external electrode 22 may be provided on a portion of the first main surface 3, a portion of the second main surface 4, a portion of the first lateral surface 5, and a portion of the second lateral surface 6. In the present example embodiment, the second external electrode 22 extends from the second end surface 9 to a portion of the first main surface 3, a portion of the second main surface 4, a portion of the first lateral surface 5, and a portion of the second lateral surface 6.

Each of the external electrodes preferably includes a base electrode layer 25 and a plated layer. The base electrode layer 25 includes at least one of, for example a fired layer, an electrically conductive resin layer, and a thin film layer.

A case where the base electrode layer 25 is a fired layer will be described. The fired layer includes a glass component and a metal. The glass component includes at least one of, for example, B, Si, Ba, Mg, Al, or Li. The metal includes at least one of, for example, Cu, Ni, Ag, Pd, Ag—Pd alloy, or Au. The fired layer may include a plurality of layers.

The fired layer is a layer formed by applying an electrically conductive paste to the multilayer body 2, and then firing the resultant product. The electrically conductive paste includes a glass component and a metal.

The firing of the fired layer may be performed simultaneously with the firing of the internal electrode layers and the dielectric layers. This firing is referred to as co-firing. The firing of the fired layer may be performed after firing the internal electrode layers and the dielectric layers. When performing co-firing, preferably, a dielectric material is blended into the electrically conductive paste instead of the glass component.

Preferred thicknesses of the fired layer are as follows. At the middle position in the lamination direction T, the preferred thickness of the fired layer on the end surface in the length direction L is, for example, about 3 μm or more and about 160 μm or less. At the middle position in the lamination direction T, the preferred thickness of the fired layer on the lateral surface in the width direction W is, for example, about 3 μm or more and about 40 μm or less. At the middle position in the width direction W, the preferred thickness of the fired layer on the main surface in the lamination direction T is, for example, about 3 μm or more and about 40 μm or less.

A case where the base electrode layer 25 is an electrically conductive resin layer will be described. The electrically conductive resin layer includes a thermosetting resin and a metal. The electrically conductive resin layer includes a thermosetting resin. Therefore, the flexibility of the electrically conductive resin layer is higher than that of a conductive layer made of a plated layer and a fired product of an electrically conductive paste.

The electrically conductive resin layer defines and functions as a buffer layer when a shock is applied to the multilayer ceramic capacitor. Therefore, it is possible for the electrically conductive resin layer to reduce or prevent the occurrence of cracks in the multilayer ceramic capacitor. The shock applied to the multilayer ceramic capacitor includes physical shock and shock caused by thermal cycles.

The metal included in the electrically conductive resin layer may be, for example, at least one of Ag, Cu, Ni, Sn, Bi, or an alloy including these metals. The metal included in the electrically conductive resin layer may be, for example, metal powder.

The surface of the metal powder may be coated with, for example, Ag. When using metal powder having surfaces coated with Ag, a preferred material for the metal powder is, for example, Cu, Ni, Sn, Bi, or an alloy thereof.

A preferred metal included in the electrically conductive resin layer is Ag. This is because Ag has the lowest specific resistance among metals. Therefore, Ag is suitable as an electrode material. Also, this is because Ag is a precious metal. Therefore, Ag does not oxidize and has high weather resistance.

When Ag is used as a coating material, even if the base metal is an inexpensive metal, the metal powder can have the characteristics of Ag.

The metal included in the electrically conductive resin layer may be, for example, a metal in which Cu or Ni is subjected to anti-oxidation treatment.

Further, the surface of the metal powder included in the electrically conductive resin layer may be coated with, for example, Sn, Ni, or Cu. When using metal powder coated with Sn, Ni, or Cu, a preferred base metal is, for example, Ag, Cu, Ni, Sn, Bi, or an alloy thereof.

A preferred content of metal with respect to the total volume of the electrically conductive resin is, for example, about 35 vol % or more and about 75 vol % or less.

The metal included in the electrically conductive resin layer is not particularly limited. The metal included in the electrically conductive resin layer may be an electrically conductive filler, for example. The shape of the electrically conductive filler may be spherical or flat, for example.

The average particle size of the metal included in the electrically conductive resin layer is not particularly limited. When the metal is an electrically conductive filler, the average particle size of the electrically conductive filler can be, for example, about 0.3 μm or more and about 10 μm or less.

The metal included in the electrically conductive resin layer mainly provides electrical conductivity to the electrically conductive resin layer. When the metal is an electrically conductive filler, electrically conductive fillers contact each other to provide an electric conduction path inside the electrically conductive resin layer.

When the metal is an electrically conductive filler, it is preferable to use a mixture of spherical electrically conductive fillers and flat-shaped electrically conductive fillers.

The resin included in the electrically conductive resin layer may be a thermosetting resin such as, for example, an epoxy resin, phenoxy resin, phenol resin, urethane resin, silicone resin, or polyimide resin. Among these, for example, a suitable resin is an epoxy resin. This is because epoxy resins have excellent heat resistance, moisture resistance, and adhesion.

A preferred content of the resin with respect to the total volume of the electrically conductive resin is, for example, about 25 vol % or more and about 65 vol % or less.

The electrically conductive resin layer preferably includes a curing agent together with the thermosetting resin. When an epoxy resin is used as the base resin, preferred curing agents are compounds such as, for example, phenol-based, amine-based, acid anhydride-based, imidazole-based, active ester-based, or amidoimide-based compounds.

A preferred thickness of the electrically conductive resin layer is as follows. At the middle position in the lamination direction T, a preferred thickness of the electrically conductive resin layer on the end surface in the length direction L is, for example, about 3 μm or more and about 160 μm or less.

When the electrically conductive resin layer is provided on the main surface and the lateral surface in addition to the end surface, a preferred thickness of the electrically conductive resin layer is as follows. At the middle position in the lamination direction T, a preferred thickness of the electrically conductive resin layer on the lateral surface in the width direction W is, for example, about 3 μm or more and about 40 μm or less. At the middle position in the width direction W, a preferred thickness of the electrically conductive resin layer on the main surface in the lamination direction T is, for example, about 3 μm or more and about 40 μm or less.

The electrically conductive resin layer may include a plurality of layers.

The electrically conductive resin layer is directly provided on the multilayer body 2. The electrically conductive resin layer may be provided on the fired layer so as to cover the fired layer.

A case where the base electrode layer 25 is a thin film layer will be described. The thin film layer is a layer in which metal particles are deposited on the multilayer body 2. The thickness of the thin film layer is, for example, about 1 μm or less. Examples of the method for forming the thin film layer include a thin film forming method such as a sputtering method or a vapor deposition method.

The plated layer will be described. The material of the plated layer includes, for example, at least one of Cu, Ni, Sn, Ag, Pd, Ag—Pd alloy, or Au. The plated layer may include a plurality of layers.

A preferred layer configuration of the plated layer is a two-layer configuration. In the present example embodiment, the plated layer includes, for example, a first plated layer 27 and a second plated layer 28. The first plated layer 27 is a plated layer that covers the base electrode layer 25. The second plated layer 28 is a plated layer that covers the first plated layer 27.

The first plated layer 27 is, for example, preferably a Ni plated layer. The second plated layer 28 is, for example, preferably a Sn plated layer.

The Ni plated layer reduces or prevents the base electrode layer from being eroded by solder when mounting the multilayer ceramic capacitor. The Sn plated layer improves the wettability of solder when mounting the multilayer ceramic capacitor. As a result, mounting of the multilayer ceramic capacitor is facilitated.

A preferred thickness of each plated layer is, for example, about 2 μm or more and about 15 μm or less.

The external electrode may include only a plated layer, without including a base electrode layer. A case where a plated layer is provided without providing a base electrode layer will be described.

The plated layer is directly provided on the surface of the multilayer body 2. This plated layer defines and functions as the external electrode. This plated layer is referred to as a plated electrode. The internal electrode layer is directly electrically connected to the plated electrode.

When forming the plated layer on the surface of the multilayer body 2, pretreatment may be performed. The pretreatment is a treatment for providing a catalyst on the surface of the multilayer body 2.

The plated electrode preferably includes a lower plated electrode and an upper plated electrode. The lower plated electrode is a plated layer provided on the surface of the multilayer body 2. The upper plated electrode is a plated layer provided on the surface of the lower plated electrode.

Preferred materials for the lower plated electrode and the upper plated electrode are, for example, at least one of Cu, Ni, Sn, Pb, Au, Ag, Pd, Bi, Zn, or alloys including at least one of these metals.

The lower plated electrode is preferably made of Ni, for example. The reason is that the Ni plated layer has a solder barrier property.

The upper plated electrode is preferably made of Sn or Au, for example. The reason is that the Sn plated layer and the Au plated layer have solder wettability.

When the internal electrode layer is made of Ni, the preferred material for the lower plated electrode is Cu, for example. The reason is that Cu has a good bonding property with Ni.

The upper plated electrode may be provided as necessary. The plated electrode may include only the lower plated electrode.

The outermost layer of the plated electrode may be the upper plated electrode. Alternatively, another plated layer may be further provided on the surface of the upper plated electrode. When another plated layer is provided, the outermost layer of the plated electrode corresponds to the newly formed other plated layer.

A preferred thickness of each layer of the plated layer in the plated electrode is, for example, about 1 μm or more and about 15 μm or less.

The plated layer in the plated electrode preferably does not include glass. A preferred ratio of metal per unit volume of the plated layer is, for example, about 99 vol % or more.

Regarding the dimensions of the multilayer ceramic capacitor 1 including the multilayer body 2, the first external electrode 21, and the second external electrode 22, the L dimension corresponds to the length of the multilayer ceramic capacitor 1 in the length direction L. The W dimension corresponds to the length of the multilayer ceramic capacitor 1 in the width direction W. The T dimension corresponds to the length of the multilayer ceramic capacitor 1 in the lamination direction T. A preferred L dimension is, for example, about 0.2 mm or more and about 1.0 mm or less. A preferred W dimension is, for example, about 0.1 mm or more and about 0.5 mm or less. A preferred T dimension is, for example, about 0.1 mm or more and about 0.5 mm or less.

An example of a manufacturing method of the multilayer ceramic capacitor according to an example embodiment of the present invention will be described. The dimensions of the multilayer ceramic capacitor are as follows. L dimension×W dimension×T dimension=about 6 mm×about 3 mm×about 3 mm, for example.

### (1) Providing a Dielectric Sheet and an Electrically Conductive Paste for Manufacturing Internal Electrode Layers

The dielectric sheet and the electrically conductive paste for manufacturing internal electrode layers include a binder and a solvent. The binder and the solvent may be those known in the art.

### (2) Forming an Internal Electrode Layer Pattern on the Dielectric Sheet

Examples of the method of forming the internal electrode layer pattern include printing of the electrically conductive paste for manufacturing internal electrode layers on the dielectric sheet. The printing of the electrically conductive paste is performed in a predetermined pattern. Examples of the printing method include screen printing and gravure printing.

### (3) Laminating a Predetermined Number of Dielectric Sheets for Manufacturing the Outer Layer

No internal electrode layer pattern is printed on the dielectric sheets for manufacturing the outer layer. Subsequently, dielectric sheets with printed internal electrode layer patterns are sequentially laminated thereon. Furthermore, a predetermined number of dielectric sheets for manufacturing the outer layer are laminated thereon. Thus, a multilayer sheet is produced.

### (4) Pressing the Multilayer Sheet in the Lamination Direction

Examples of the pressing include hydrostatic pressing or the like. The pressed multilayer sheet defines and functions as a multilayer block. The multilayer block is also referred to as a mother multilayer body.

### (5) Cutting the Pressed Mother Multilayer Body into Chip Shapes

By cutting the mother multilayer body, multilayer body chips are obtained. Examples of the method for cutting the mother multilayer body include push cutting, dicing, and laser cutting. The corner portions and ridge portions of the obtained multilayer body chips may be rounded. Examples of the method for rounding include barrel polishing or the like.

### (6) Firing the Multilayer Body Chips

A preferred firing temperature is, for example, about 900° C. or more and about 1400° C. or less. The firing temperature may be changed according to the material of the dielectric or the material of the internal electrode layer. The fired multilayer body chips function as multilayer bodies.

(7) Oxidizing the internal electrode layers exposed on both end surfaces of the multilayer body to form oxide films. Specifically, the internal electrode layers exposed on the first end surface of the multilayer body and the internal electrode layers exposed on the second end surface of the multilayer body are oxidized. Oxide films are formed by the oxidation treatment. Examples of the method of oxidation treatment include firing of the multilayer body. The firing temperature is, for example, about 700° C. or more and about 900° C. or less.

The preferred range of oxygen partial pressure varies depending on the firing temperature. The oxygen partial pressure is the pressure attributed to oxygen among all gases in the firing furnace. A preferred oxygen partial pressure at a temperature of about 700° C. is, for example, about 10⁻¹⁹ Pa or more and about 10⁻¹⁷ Pa or less. A preferred oxygen partial pressure at a temperature of about 900° C. is, for example, about 10⁻¹⁵ Pa or more and about 10⁻¹³ Pa or less.

Within the firing temperature range of about 700° C. or more and about 900° C. or less, by setting a predetermined logarithmic oxygen partial pressure and appropriately adjusting the firing time, Ni of the internal electrode layers exposed on the first end surface and the second end surface becomes NiO. As a result, oxide films with a desired ratio are formed at both end portions in the width direction of the internal electrode layers.

Another example of a method for forming oxide films will be described. The middle region of the end surface of the multilayer body where the internal electrode layers are exposed is covered with Cu metal. Examples of the covering method include sputter deposition. By covering the middle region of the end surface of the multilayer body, oxidation of the middle region of the end surface of the internal electrode layers is reduced or prevented. This is because the portion covered with Cu metal is less likely to oxidize even when the multilayer body is fired.

After covering with Cu metal, the multilayer body is fired. The firing temperature is, for example, about 700° C. or more and about 900° C. or less. By this firing, oxide films are formed.

After forming the oxide films, the Cu metal covering the middle region of the end surface of the multilayer body is removed. The removal of Cu metal can be performed using sodium peroxodisulfate.

### (8) Forming External Electrodes on the Multilayer Body

First, a base electrode layer is formed on the multilayer body. The base electrode layer can be selected from a fired layer, an electrically conductive resin layer, a thin film layer, and the like, for example.

A case where the base electrode layer is formed as a fired layer will be described. An electrically conductive paste for manufacturing external electrodes on both end surfaces of the multilayer body is applied. After the application, the electrically conductive paste is fired. A preferred temperature for firing is, for example, about 700° C. or more and about 900° C. or less. By this firing, a fired layer is formed.

### (9) Applying Plating on the Surface of the Fired Layer if Necessary

The plated layer will be described later.

A case where the base electrode layer is formed with an electrically conductive resin layer will be described. The electrically conductive resin layer may be formed directly on the multilayer body by itself. Alternatively, the electrically conductive resin layer may be formed on the surface of the fired layer.

In forming the electrically conductive resin layer, first, an electrically conductive resin paste is applied on the fired layer or on the multilayer body. The electrically conductive resin paste includes a thermosetting resin and a metal component. The applied electrically conductive resin paste is subjected to heat treatment. The temperature of the heat treatment is, for example, about 250° C. or more and about 550° C. or less. By the heat treatment, the electrically conductive resin paste is thermally cured. Thus, the electrically conductive resin layer is formed.

The preferred atmosphere during heat treatment is an N₂ atmosphere. A preferred oxygen concentration during heat treatment is, for example, about 100 ppm or less. This is because scattering of the resin is reduced or prevented and oxidation of the metal component is reduced or prevented.

If necessary, plating is applied on the surface of the electrically conductive resin layer. The plated layer will be described later.

A case where the base electrode layer is formed as a thin film layer will be described. The thin film layer can be formed by a thin film forming method. Specific examples of the thin film forming method include a sputtering method and/or a vapor deposition method.

The thin film layer is a layer in which metal particles are deposited. The thickness of the thin film layer is, for example, about 1 μm or less.

If necessary, plating is applied on the surface of the thin film layer. The plated layer will be described later.

A case where a plated layer is formed without providing a base electrode layer will be described. In forming the external electrode, a plated layer may be provided on the exposed portion of the internal electrode layer of the multilayer body without providing a base electrode layer. This plated layer is the plated electrode. The plated electrode is formed as follows.

Plating treatment is conducted on both end surfaces of the multilayer body. With such a configuration, a plated layer is formed on the exposed portion of the internal electrode layer. This plated layer defines and functions as the plated electrode.

The plated electrode may include two plated layers. When the plated electrode includes two plated layers, the plated layer formed on the exposed portion of the internal electrode layer defines and functions as the lower plated electrode. An upper plated electrode can be formed on the surface of this lower plated electrode. In this case, the combination of the lower plated electrode and the upper plated electrode defines and functions as the plated electrode.

The plating treatment method may be either electrolytic plating or electroless plating. However, electroless plating requires pretreatment with a catalyst or the like in order to improve the plating deposition rate. Therefore, the electroless plating process may be complicated. Therefore, a preferred method of plating treatment is electrolytic plating. In addition, the preferred plating method is the barrel plating method.

(10) A plated layer may be formed on the surface of the base electrode layer, the surface of the electrically conductive resin layer, the surface of the lower plated electrode of the plated electrode, and the surface of the upper plated electrode of the plated electrode.

In the present example embodiment, the base electrode layer is formed as a fired layer. Then, for example, a Ni plated layer and a Sn plated layer are formed on the fired layer. Examples of the method of forming the Ni plated layer and the Sn plated layer include the barrel plating method. The Ni plated layer and the Sn plated layer are formed sequentially. In this way, the external electrode is formed.

As described above, the multilayer ceramic capacitor including the oxide film formed thereon is manufactured.

An example of a manufacturing method of a multilayer ceramic capacitor different from the above will be described. The multilayer ceramic capacitor can be manufactured by a manufacturing method different from manufacturing method 1.

The dimensions of the multilayer ceramic capacitor are as follows. L dimension×W dimension×T dimension=about 6 mm×about 3 mm×about 3 mm, for example.

### (1) Providing a Perovskite Compound Including Ba and Ti as a Dielectric Ceramic Material

Additives, an organic binder, an organic solvent, a plasticizer, and a dispersant are mixed in predetermined proportions with the dielectric powder obtained from this dielectric ceramic material. This mixture provides a ceramic slurry. The additives include, for example, at least one of Si, Mg, or Ba.

A ceramic green sheet is formed by placing a ceramic slurry on a surface of a resin film. Examples of the resin film include, for example, a PET film.

Examples of the formation method of the ceramic green sheet include a printing method. Specific examples of the printing method are those using a die coater, a gravure coater, and a micro gravure coater.

### (2) Placing Subsequently an Electrically Conductive Paste for Manufacturing Internal Electrode Layers on the Ceramic Green Sheet

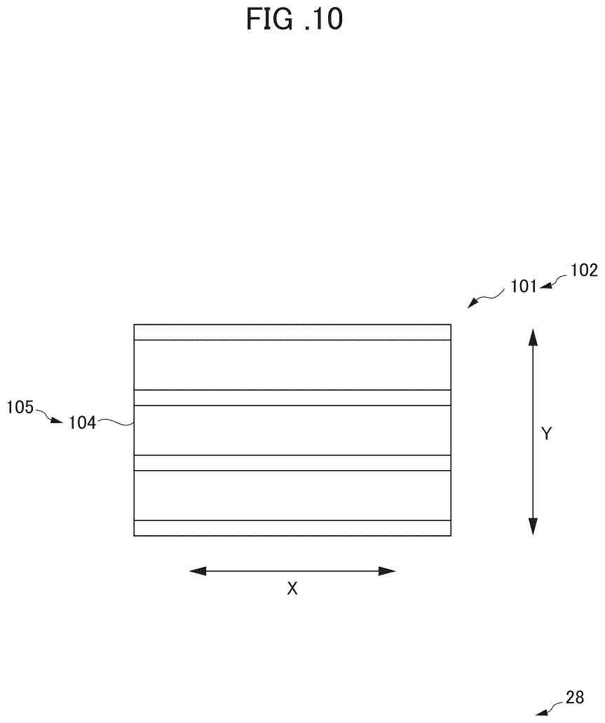

FIG. 10 is a diagram showing a state in which the ceramic green sheet is viewed in a plan view. The ceramic green sheet includes a first ceramic green sheet 101 and a second ceramic green sheet 102. The first ceramic green sheet 101 and the second ceramic green sheet 102 are the same or substantially the same. The first ceramic green sheet 101 and the second ceramic green sheet 102 are alternately laminated while being shifted upon laminating. The lamination will be described later.

Next, an electrically conductive film is formed on the surface of the ceramic green sheet. The electrically conductive film includes a first electrically conductive film 104 that corresponds to a first internal electrode layer and a second electrically conductive film 105 that corresponds to a second internal electrode layer.

The formation of the electrically conductive film is performed by printing the electrically conductive paste for manufacturing internal electrode layers on the surface of the ceramic green sheet. The electrically conductive paste for manufacturing internal electrode layers is printed in a stripe pattern. The electrically conductive film is formed by drying the electrically conductive paste for manufacturing internal electrode layers.

Examples of printing methods for the electrically conductive paste for manufacturing internal electrode layers are screen printing, inkjet printing, and gravure printing. As an example, the thickness of the conductive film is about 1.5 μm or less.

The direction in which the electrically conductive paste for internal electrode layers extends in a stripe pattern is defined as an X direction. A direction orthogonal or substantially orthogonal to the X direction is defined as a Y direction. The Y direction is the same as the width direction of the conductive film.

### (3) Laminating the Ceramic Green Sheets

First, a predetermined number of ceramic green sheets on which no electrically conductive film is formed are laminated. This laminated portion corresponds to one of the outer layer portions.

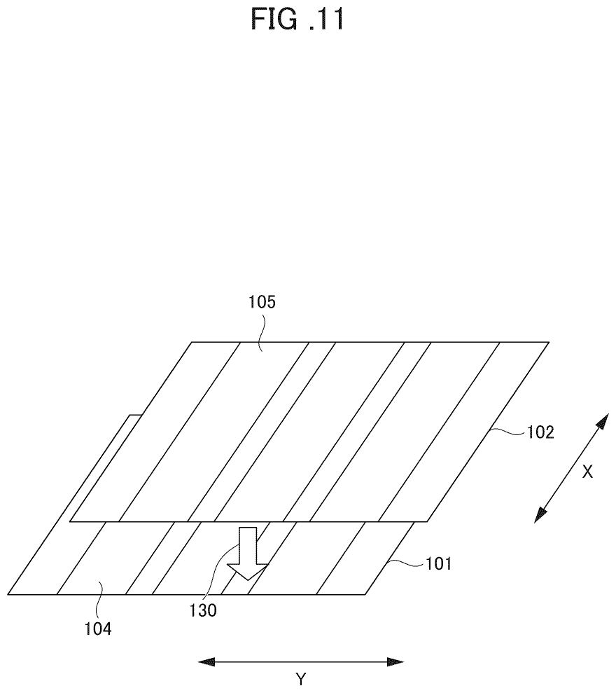

Next, ceramic green sheets that correspond to an effective layer portion are laminated. FIG. 11 is a diagram showing a state of laminating the ceramic green sheets. As shown in FIG. 11, the first ceramic green sheet 101 and the second ceramic green sheet 102 are alternately laminated in a predetermined number. The arrow 130 in FIG. 11 indicates the direction of lamination. The first electrically conductive film 104 that corresponds to the first internal electrode layer is formed on the first ceramic green sheet 101. The second electrically conductive film 105 that corresponds to the second internal electrode layer is formed on the second ceramic green sheet 102.

The first ceramic green sheet 101 and the second ceramic green sheet 102 are laminated while being shifted in the Y direction. This laminated portion corresponds to the effective layer portion.

Furthermore, layers defining and functioning as the other outer layer portion are laminated. Ceramic green sheets on which no electrically conductive film is formed are further laminated in a predetermined number. This laminated portion corresponds to the other outer layer portion.

Through the above steps, a mother multilayer body is obtained.

### (4) Pressing the Obtained Mother Multilayer Body

Examples of pressing methods include rigid pressing and hydrostatic pressing.

### (5) Cutting the Pressed Mother Multilayer Body into Chip Shapes

Thereby, multilayer body chips are obtained. Examples of methods for cutting the mother multilayer body include push cutting, dicing, and laser.

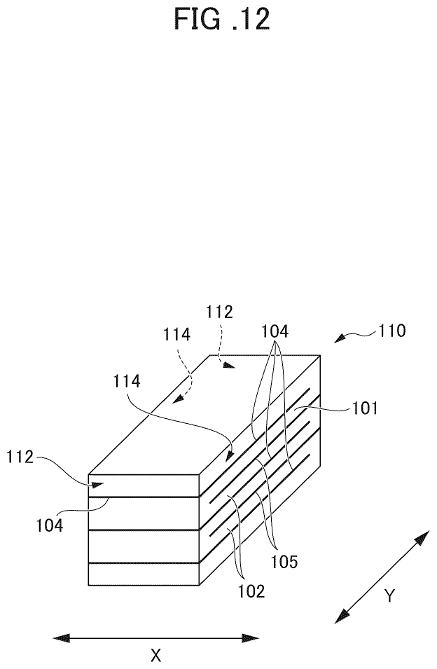

(6) FIG. 12 is a diagram showing an overview of the multilayer body chip 110. As shown in FIG. 12, on one end surface 112 of the multilayer body chip 110 obtained through the above steps, only the first electrically conductive film 104 defining and functioning as the first internal electrode layer formed on the first ceramic green sheet 101 is exposed. Also, on the other end surface 112, only the second electrically conductive film 105 defining and functioning as the second internal electrode layer formed on the second ceramic green sheet 102 is exposed.

On both lateral surfaces 114 of the multilayer body chip 110, both the first electrically conductive film 104 defining and functioning as the first internal electrode layer formed on the first ceramic green sheet 101 and the second electrically conductive film 105 defining and functioning as the second internal electrode layer formed on the second ceramic green sheet 102 are exposed.

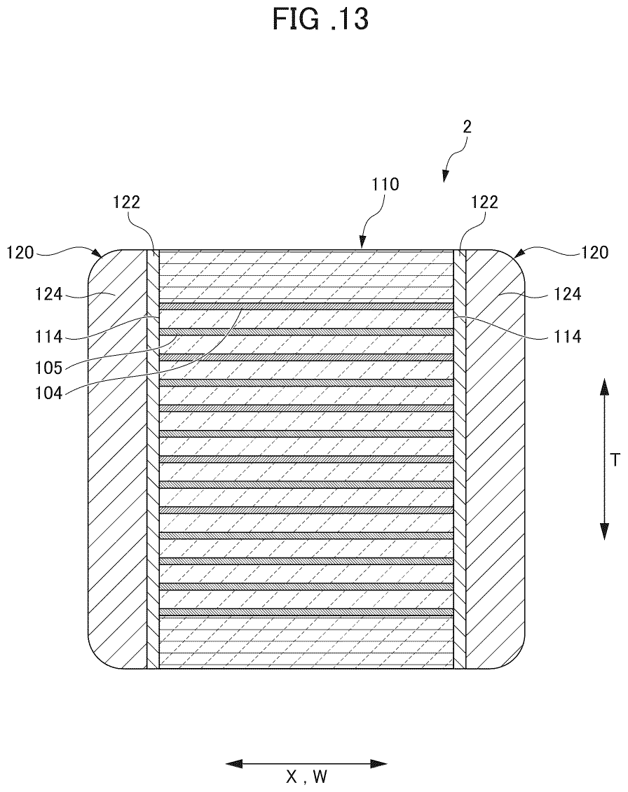

(7) Formation of the side margin portion 120 will be described. FIG. 13 is a diagram showing a WT cross section of the multilayer body 2. The side margin portion 120 includes an inner layer 122 and an outer layer 124.

First, a ceramic green sheet for manufacturing a side margin defining and functioning as the side margin portion 120 is prepared. As a dielectric ceramic material, a perovskite compound including, for example, Ba and Ti is prepared.

Additives, binder resin, organic solvent, plasticizer, and dispersant are mixed with the dielectric powder obtained from this dielectric ceramic material at predetermined ratios. Thus, a ceramic slurry is prepared. The additives include, for example, at least one of Si, Mg, Ni, or Ba.

Si is added to the ceramic slurry defining and functioning as the outer layer 124 of the side margin portion 120. A preferred amount of Si to be added is such that the ratio of the number of moles of Si to the number of moles of Ti is, for example, about 1.0 or more and about 7.0 or less.

Si is also added to the ceramic slurry that defines and functions as the inner layer 122 of the side margin portion 120. A preferred addition amount of Si is an amount such that the number of moles of Si/the number of moles of Ti is, for example, about 1.0 or more and about 4.0 or less. The above-described addition amount of Si is an example.

Ba is added to the ceramic slurry that defines and functions as the outer layer 124 of the side margin portion 120. A preferred addition amount of Ba is an amount such that the number of moles of Ba/the number of moles of Ti is, for example, about 0.00 or more and less than about 0.02.

Ba is also added to the ceramic slurry that defines and functions as the inner layer 122 of the side margin portion 120. A preferred addition amount of Ba is an amount such that the number of moles of Ba/the number of moles of Ti is, for example, about 0.02 or more and less than about 0.04. The above-described addition amount of Ba is an example.

The amount of polyvinyl chloride (PVC) included in the ceramic slurry that defines and functions as the outer layer 124 of the side margin portion 120 is greater than the amount of polyvinyl chloride included in the ceramic slurry that defines and functions as the inner layer 122 of the side margin portion 120.

For the solvent included in the ceramic slurry that defines and functions as the inner layer 122 of the side margin portion 120, an optimal solvent is appropriately selected in order to prevent dissolution of the ceramic green sheet for manufacturing the outer layer.

The ceramic green sheet for manufacturing the inner layer has a role of bonding with the multilayer body chip 110.

(8) The prepared ceramic slurry that defines and functions as the outer layer 124 is applied to the surface of the resin film, and allowed to dry. Thus, a ceramic green sheet for manufacturing the outer layer is obtained.

(9) The prepared ceramic slurry that defines and functions as the inner layer 122 is applied to the surface of the ceramic green sheet for the outer layer, and allowed to dry. Thus, a ceramic green sheet for manufacturing the inner layer is formed.

As described above, a ceramic green sheet for manufacturing the side margin with a two-layer configuration is obtained.

It is preferable that the dimension along the width direction of the ceramic green sheet for the inner layer is smaller than the dimension along the width direction of the ceramic green sheet for the outer layer.

The ceramic green sheet for manufacturing the outer layer is preferably formed such that the thickness after firing is, for example, about 5 μm or more and about 20 μm or less. The ceramic green sheet for manufacturing the inner layer is preferably formed such that the thickness after firing is, for example, about 0.1 μm or more and about 20 μm or less.

(10) A case has been described in which the ceramic green sheet for manufacturing the side margin having a two-layer configuration is obtained by applying and drying the ceramic green sheet for manufacturing the inner layer on the surface of the ceramic green sheet for manufacturing the outer layer. Examples of other methods for forming the ceramic green sheet for manufacturing the side margin include the following method.

The ceramic green sheet for manufacturing the outer layer and the ceramic green sheet for manufacturing the inner layer are each formed in advance. Thereafter, the ceramic green sheet for manufacturing the outer layer and the ceramic green sheet for manufacturing the inner layer are bonded together to obtain the ceramic green sheet for manufacturing the side margin with a two-layer configuration.

In addition, the configuration of the ceramic green sheet for manufacturing the side margin is not limited to the two-layer configuration, and may be a three or more-layer configuration.

(11) Next, the ceramic green sheet for manufacturing the side margin is peeled from the resin film (PET film). Thereafter, the ceramic green sheet for manufacturing the inner layer in the peeled ceramic green sheet for manufacturing the side margin is made to oppose the lateral surface 114 of the multilayer body chip 110 where the first electrically conductive film 104 defining and functioning as the first internal electrode layer and the second electrically conductive film 105 defining and functioning as the second internal electrode layer are exposed. Then, the ceramic green sheet for manufacturing the side margin and the multilayer body chip 110 are pressed together, and subsequently punched out, such that a layer defining and functioning as the side margin portion 120 is formed.

For the other lateral surface 114 of the multilayer body chip 110 where the layer defining and functioning as the side margin portion is not formed, a layer defining and functioning as the side margin portion 120 is formed by the same or substantially the same process.

When forming the layer defining and functioning as the side margin portion 120, preferably, an organic solvent defining and functioning as an adhesive is applied in advance to the lateral surface 114 of the multilayer body chip 110.

(12) Formation of the multilayer body will be described. The multilayer body chip 110 on which the layer defining and functioning as the side margin portion 120 is formed is subjected to a degreasing treatment under predetermined conditions in, for example, a nitrogen atmosphere. After the degreasing treatment, the multilayer body chip 110 is fired at a predetermined temperature in, for example, a nitrogen-hydrogen-water vapor mixed atmosphere. By this firing, a sintered multilayer body is obtained.

(13) The internal electrode layers exposed on both end surfaces of the multilayer body are subjected to oxidation treatment to form an oxide film. Specifically, the internal electrode layers exposed on the first end surface of the multilayer body and the internal electrode layers exposed on the second end surface of the multilayer body are subjected to oxidation treatment. An oxide film is formed by the oxidation treatment. The method of oxidation treatment is firing of the multilayer body. The firing temperature is, for example, about 700° C. or more and about 900° C. or less.

The preferred range of oxygen partial pressure varies depending on the temperature during firing. The oxygen partial pressure is the pressure attributed to oxygen among all gases in the firing furnace. A preferred oxygen partial pressure when the temperature is about 700° C. is, for example, about 10⁻¹⁹ Pa or more and about 10⁻¹⁷ Pa or less. A preferred oxygen partial pressure when the temperature is about 900° C. is, for example, about 10⁻¹⁵ Pa or more and about 10⁻¹³ Pa or less.

By setting a predetermined logarithmic oxygen partial pressure within a firing temperature of about 700° C. or more and about 900° C. or less and appropriately adjusting the firing time, Ni of the internal electrode layers exposed at the first end surface and the second end surface becomes NiO. As a result, an oxide film having a desired ratio is formed at both end portions in the width direction of the internal electrode layers.

Another example of a method for forming the oxide film will be described. The middle region of the end surface of the multilayer body where the internal electrode layers are exposed is covered with Cu metal, for example. Examples of the covering method include sputter deposition. By covering the middle region of the end surface of the multilayer body, oxidation of the middle region of the end surface of the internal electrode layers is reduced or prevented. This is because the portion covered with Cu metal is difficult to oxidize even when the multilayer body is fired.

After covering with Cu metal, the multilayer body is fired. The firing temperature is, for example, about 700° C. or more and about 900° C. or less. By this firing, an oxide film is formed.

After forming the oxide film, the Cu metal covering the middle region of the end surface of the multilayer body is removed. The removal of Cu metal can be performed, for example, using sodium peroxodisulfate.

(14) External electrodes are formed on the multilayer body. An electrically conductive paste for manufacturing external electrodes including Cu as a main component is applied to each of the two end surfaces of the sintered multilayer body. After the application, the electrically conductive paste is fired. A preferred firing temperature is, for example, about 700° C. or more and about 900° C. or less. By firing, a fired layer is formed.

Subsequently, a Ni plated layer and a Sn plated layer are formed on the fired layer. Examples of the method for forming the Ni plated layer and the Sn plated layer include barrel plating. The Ni plated layer and the Sn plated layer were formed sequentially. In this way, the external electrodes are formed.

As described above, a multilayer ceramic capacitor including an oxide film formed thereon is manufactured.

Hereinafter, the present invention will be described in more detail with reference to Experimental Examples. However, the following description is provided to facilitate specific understanding of the present invention. The scope of the present invention is not limited by the Experimental Examples.

### EXPERIMENTAL EXAMPLE 1

Multilayer ceramic capacitors were prepared according to the above manufacturing method. For each of the prepared multilayer ceramic capacitors, the deterioration state of the insulation resistance value by a moisture resistance test was confirmed.

An example of a method of the moisture resistance test is as follows. The multilayer ceramic capacitor was mounted on a wiring substrate using eutectic solder. Subsequently, the insulation resistance value of each sample was measured. Next, the wiring substrate was placed in a high-temperature and high-humidity chamber, and under an environment of about 85° C. and relative humidity of about 85% RH, a DC current of about 4.8 V was applied between the pair of external electrodes for each sample, and this state was maintained for about 216 hours. Subsequently, the insulation resistance value of each sample after the moisture resistance test was measured.

Then, for each sample, those having 0 samples with an insulation resistance value of about 1 mΩ or more after the test were determined as “○” (circle symbol indicating good). Those having 2 or more samples with an insulation resistance value of about 1 mΩ or more were determined as “×” (cross symbol indicating poor). The moisture resistance test was conducted by preparing 100 samples for each sample number.

In addition, those with an insulation resistance value of about 1 mΩ or more were counted as the number with deteriorated insulation resistance.

Hereinafter, the Examples and Comparative Examples in Experimental Example 1 will be specifically described. The multilayer ceramic capacitors of the Examples and Comparative Examples were multilayer ceramic capacitors manufactured by the manufacturing method 1 described above.

### EXAMPLE 1

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 0.5% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### COMPARATIVE EXAMPLE 1

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations: No oxide film formation at both end portions in the width direction of the internal electrode layer
External electrode configuration:
Base electrode layer: electrode including an electrically conductive metal (Cu) and a glass component
Lower plated layer: Ni plated layer made of Ni and Sn plated layer made of Sn

### COMPARATIVE EXAMPLE 2

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed only at the end adjacent to the first lateral surface in the width direction of the internal electrode layer, with a length of about 0.5% of the total length in the width direction of the internal electrode layer. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### COMPARATIVE EXAMPLE 3

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

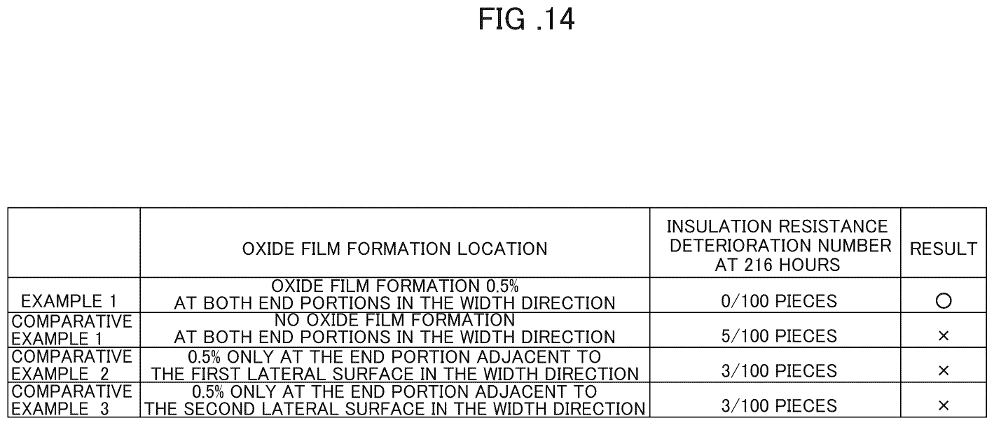

A first oxide film and a second oxide film were formed only at the end adjacent to the second lateral surface in the width direction of the internal electrode layer, with a length of about 0.5% of the total length in the width direction of the internal electrode layer. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn FIG. 14 shows the evaluation results. FIG. 14 is a table showing the results of Experimental Example 1. As shown in FIG. 14, it was confirmed from the experimental data that deterioration of insulation resistance can be reduced or prevented by forming oxide films at both end portions in the width direction.

### EXPERIMENTAL EXAMPLE 2

In Experimental Example 2, in addition to the moisture resistance test of Experimental Example 1, ESR (equivalent series resistance) values were measured and evaluated.

The method of the moisture resistance test is as follows. The multilayer ceramic capacitor was mounted on a wiring substrate using eutectic solder. Subsequently, the insulation resistance value of each sample was measured. Next, the wiring substrate was placed in a high-temperature and high-humidity chamber, and under an environment of about 85° C. and relative humidity of about 85% RH, a DC current of about 4.8 V was applied between the pair of external electrodes for each sample, and this state was maintained for about 216 hours. Subsequently, the insulation resistance value of each sample after the moisture resistance test was measured.

ESR (equivalent series resistance) was measured using a precision LCR meter (manufactured by Agilent: E4980A) under conditions of a measurement frequency of about 1 MHz and a measurement voltage of about 500 mV.

For each sample, those having an insulation resistance value after the test of about 1 mΩ or more were 0, and those having an average ESR (equivalent series resistance) value of about 15 mΩ or less were determined as “○” (circle symbol indicating good). Those having an insulation resistance value of about 1 mΩ or more were 1 or more and less than 2, and those having an average ESR (equivalent series resistance) of about 15 mΩ or more and about 100 mΩ or less were determined as “Δ” (triangle symbol indicating fair). The moisture resistance test was conducted by preparing 100 samples for each sample number.

Those having an insulation resistance value of about 1 mΩ or more were counted as the number with deteriorated insulation resistance. The average value of ESR is the result of the average value of 100 samples.

Hereinafter, the examples in Experimental Example 2 will be specifically described. The multilayer ceramic capacitors of the Examples and Comparative Examples are multilayer ceramic capacitors manufactured by the manufacturing method 1 described above.

### EXAMPLE 2

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 0.3% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 3

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 0.4% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 4

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 0.5% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

Example 4 is a sample under the same or substantially the same conditions as Example 1 of Experimental Example 1.

### EXAMPLE 5

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 3% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 6

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 7% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 7

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 10% of the total length in the width direction of the internal electrode layer from each end. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 8

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 13% of the total length in the width direction of the internal electrode layer from each end portion. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 9

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 15% of the total length in the width direction of the internal electrode layer from each end portion. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 10

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 16% of the total length in the width direction of the internal electrode layer from each end portion. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 11

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 19% of the total length in the width direction of the internal electrode layer from each end portion. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

### EXAMPLE 12

Dimensions of multilayer ceramic capacitor: L dimension×W dimension×T dimension=about 0.6 mm×about 0.3 mm ×about 0.3 mm
Ceramic material: BaTiO₃
Capacitance: about 2.7 μF
Rated voltage: about 6.3 V
Oxide film formation locations:

A first oxide film and a second oxide film were formed at both end portions in the width direction of the internal electrode layer, with a length of about 20% of the total length in the width direction of the internal electrode layer from each end portion. The first oxide film was formed from both end portions in the width direction of the first end surface toward the second end surface side, with a length of about 0.01% of the total length in the length direction of the first internal electrode layer. The second oxide film was formed from both end portions in the width direction of the second end surface toward the first end surface side, with a length of about 0.01% of the total length in the length direction of the second internal electrode layer.
External electrode configuration:
Base electrode layer: electrode including an electrically conductive metal (Cu) and a glass component
Lower plated layer: Ni plated layer made of Ni and Sn plated layer made of Sn

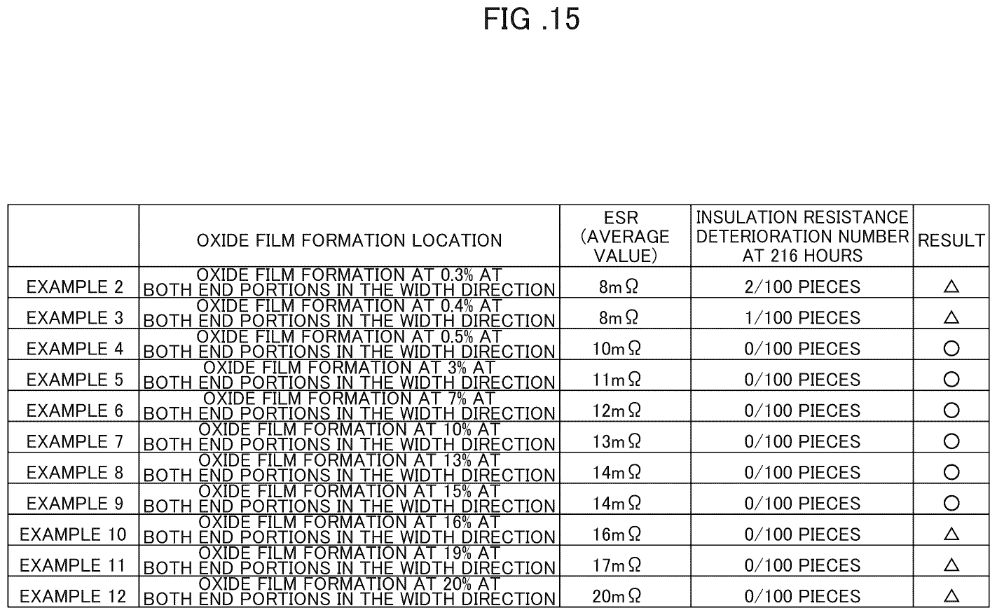

The evaluation results are shown in FIG. 15. FIG. 15 is a table showing the results of Experimental Example 2. As shown in FIG. 15, in Examples 4 to 9, since the first oxide film and the second oxide film were formed at both end portions in the width direction of the internal electrode layer with a length of about 0.5% or more and about 15% or less of the total length in the width direction of the internal electrode layer from each end portion, the insulation resistance deterioration number was 0, and the ESR was as low as about 15 mΩ or less, such that it was possible to achieve high moisture resistance reliability and high electrical conductivity.

In Examples 2 and 3, since the formation size of the oxide film was as small as less than about 0.5% of the total length in the width direction of the internal electrode layer from each end portion, the average value of ESR was about 15 mΩ or less. However, since the oxide film was formed at a ratio of less than about 0.5%, it was not possible to reduce or prevent moisture penetration from the outside. Therefore, the insulation resistance deterioration number was 1 or more and less than 2, deterioration of insulation resistance was confirmed, and it was not possible to achieve both reduction or prevention of insulation resistance deterioration and high electrical conductivity.

In Examples 10 to 12, since the oxide film was formed at both end portions in the width direction of the internal electrode layer with a length of about 15% or more of the total length in the width direction of the internal electrode layer from each end portion, the insulation resistance deterioration number was 0. However, since the oxide film was formed at a ratio exceeding about 15%, the ESR became as high as about 15 mΩ or more. Therefore, a decrease in electrical conductivity performance was confirmed, and it was not possible to achieve both reduction or prevention of insulation resistance deterioration and high electrical conductivity.

Although example embodiments of the present invention have been described above, the present invention is not limited to the above-described example embodiments, and various changes and modifications thereto are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction;
a first internal electrode layer on a corresponding one of the plurality of dielectric layers and exposed at the first end surface;
a first base electrode layer in contact with the first internal electrode layer; wherein
the first internal electrode layer includes a first end surface-side exposed portion exposed on the first end surface;
a first oxide film is provided on the first end surface-side exposed portion; and
the first oxide film is provided at both end portions in the width direction of the first end surface-side exposed portion.

2. The multilayer ceramic capacitor according to claim 1, wherein the first oxide film includes NiO.

3. The multilayer ceramic capacitor according to claim 1, wherein, in the first end surface-side exposed portion, a length of the first oxide film is in a range of about 0.5% or more and about 15% or less with respect to a total length in the width direction of each of the plurality of first internal electrode layers from both end portions in the width direction of the first end surface-side exposed portion toward a middle thereof in the width direction.

4. The multilayer ceramic capacitor according to claim 1, wherein a length of the first oxide film is in a range of about 0.01% or more and about 0.5% or less with respect to a total length in the length direction of each of the plurality of first internal electrode layers from both end portions in the width direction of the first end surface-side exposed portion toward the second end surface.

5. The multilayer ceramic capacitor according to claim 1, wherein an existence probability of the first oxide film decreases from both end portions in the width direction of the first end surface-side exposed portion approaching a middle thereof in the width direction.

6. The multilayer ceramic capacitor according to claim 2, wherein, in the first end surface-side exposed portion, a length of the first oxide film is in a range of about 0.5% or more and about 15% or less with respect to a total length in the width direction of each of the plurality of first internal electrode layers from both end portions in the width direction of the first end surface-side exposed portion toward a middle thereof in the width direction.

7. The multilayer ceramic capacitor according to claim 2, wherein a length of the first oxide film is in a range of about 0.01% or more and about 0.5% or less with respect to a total length in the length direction of each of the plurality of first internal electrode layers from both end portions in the width direction of the first end surface-side exposed portion toward the second end surface.

8. The multilayer ceramic capacitor according to claim 1, wherein the first oxide film is provided from both end portions of the first end surface-side exposed portion in the width direction toward a middle of the multilayer body in the width direction with a dimension of about 5 μm or more and about 50 μm or less.

9. The multilayer ceramic capacitor according to claim 2, wherein an existence probability of the first oxide film decreases from both end portions in the width direction of the first end surface-side exposed portion approaching a middle thereof in the width direction.

10. The multilayer ceramic capacitor according to claim 2, wherein the first oxide film is provided from both end portions of the first end surface-side exposed portion in the width direction toward a middle of the multilayer body in the width direction with a dimension of about 5 μm or more and about 50 μm or less.

11. The multilayer ceramic capacitor according to claim 1, further comprising:
a plurality of second internal electrode layers each on a corresponding one of the plurality of dielectric layers and each exposed at the second end surface;
a second base electrode layer in contact with the plurality of second internal electrode layers;
a second oxide film is provided on each of the second end surface-side exposed portion; and
the second oxide film is provided at both end portions in the width direction of the second end surface-side exposed portion.

12. The multilayer ceramic capacitor according to claim 11, wherein the second oxide film includes NiO.

13. The multilayer ceramic capacitor according to claim 11, wherein, in the second end surface-side exposed portion, a length of the second oxide film is in a range of about 0.5% or more and about 15% or less with respect to a total length in the width direction of each of the plurality of second internal electrode layers from both end portions in the width direction of the second end surface-side exposed portion toward a middle thereof in the width direction.

14. The multilayer ceramic capacitor according to claim 11, wherein a length of the second oxide film is in a range of about 0.01% or more and about 0.5% or less with respect to a total length in the length direction of each of the plurality of second internal electrode layers from both end portions in the width direction of the second end surface-side exposed portion toward the first end surface.

15. The multilayer ceramic capacitor according to claim 11, wherein an existence probability of the second oxide film decreases from both end portions in the width direction of the second end surface-side exposed portion approaching a middle thereof in the width direction.

16. The multilayer ceramic capacitor according to claim 11, wherein the second oxide film is provided from both end portions of the second end surface-side exposed portion in the width direction toward a middle of the multilayer body in the width direction with a dimension of about 5 μm or more and about 50 μm or less.

17. The multilayer ceramic capacitor according to claim 12, wherein, in the second end surface-side exposed portion, a length of the second oxide film is in a range of about 0.5% or more and about 15% or less with respect to a total length in the width direction of each of the plurality of second internal electrode layers from both end portions in the width direction of the second end surface-side exposed portion toward a middle thereof in the width direction.

18. The multilayer ceramic capacitor according to claim 12, wherein a length of the second oxide film is in a range of about 0.01% or more and about 0.5% or less with respect to a total length in the length direction of each of the plurality of second internal electrode layers from both end portions in the width direction of the second end surface-side exposed portion toward the first end surface.

19. The multilayer ceramic capacitor according to claim 12, wherein an existence probability of the second oxide film decreases from both end portions in the width direction of the second end surface-side exposed portion approaching a middle thereof in the width direction.

20. The multilayer ceramic capacitor according to claim 12, wherein the second oxide film is provided from both end portions of the second end surface-side exposed portion in the width direction toward a middle of the multilayer body in the width direction with a dimension of about 5 μm or more and about 50 μm or less.
